(19) United States
(12) Patent Application Publication
(10) Pub. No.: US 2026/0025494 A1
(43) Pub. Date: Jan. 22, 2026

(54) DECODING METHOD, ENCODING METHOD AND STORAGE MEDIUM

(71) Applicant: GUANGDONG OPPO MOBILE TELECOMMUNICATIONS CORP., LTD., Dongguan (CN)

(72) Inventors: Fan WANG, Dongguan (CN); Lai ZHANG, Dongguan (CN)

(73) Assignee: GUANGDONG OPPO MOBILE TELECOMMUNICATIONS CORP., LTD., Dongguan (CN)

(21) Appl. No.: 19/340,612

(22) Filed: Sep. 25, 2025

Related U.S. Application Data
(63) Continuation of application No. PCT/CN2023/085248, filed on Mar. 30, 2023.

(51) Int. Cl. H04N 19/105; H04N 19/159; H04N 19/176; H04N 19/70

(52) U.S. Cl. CPC H04N 19/105; H04N 19/159; H04N 19/176; H04N 19/70

(57) ABSTRACT

A decoding method, an encoding method, a decoder, and an encoder are provided. The decoding method includes: obtaining a first identifier for indicating whether filtering is performed and a first index; determining, based on a first prediction mode using intra template prediction, a first candidate list obtained based on candidate block vectors (BVs) of a current block; and determining a predicted block of the current block based on a candidate BV indicated by the first index in the first candidate list and the first identifier.

### CROSS-REFERENCE TO RELATED APPLICATION

This application is a continuation of International Patent Application No. PCT/CN2023/085248 filed on Mar. 30, 2023, disclosure of which is hereby incorporated by reference in its entirety.

### BACKGROUND

Digital video compression technologies mainly compress huge digital video data to facilitate transmission, storage and so on. With sharply increasing of Internet video and people's requirements for video definition being higher, although the existing digital video compression standards can realize the video decompression technology, it is still necessary to study better digital video decompression technologies, to improve compression efficiency.

### SUMMARY

Embodiments of the present disclosure provide a decoding method, an encoding method, a decoder, and an encoder, which can improve performance of encoding and decoding.

In a first aspect, there is provided a decoding method in an embodiment of the present disclosure, which includes: obtaining a first identifier for indicating whether filtering is performed and a first index; determining, based on a first prediction mode using intra template prediction, a first candidate list obtained based on candidate block vectors (BVs) of a current block; and determining a predicted block of the current block based on a candidate BV indicated by the first index in the first candidate list and the first identifier

In a second aspect, there is provided an encoding method in an embodiment of the present disclosure, which includes: determining, based on a first prediction mode using to intra template prediction, at least one candidate list obtained based on candidate block vectors (BVs) of a current block; determining, based on the at least one candidate list, a first identifier for indicating whether filtering is performed and a first index for indicating a candidate BV in a first candidate list of the at least one candidate list; and encoding the first identifier and the first index.

In a third aspect, there is provided non-transitory storage medium having stored thereon computer program/instructions and a bitstream, wherein when the computer program/instructions is/are executed by a processor, the computer program/instructions causes/cause the processor to perform a decoding method to decode the bitstream to generate a video or an image, the decoding method including: obtaining a first identifier for indicating whether filtering is performed and a first index; determining, based on a first prediction mode using intra template prediction, a first candidate list obtained based on candidate block vectors (BVs) of a current block; and determining a predicted block of the current block based on a candidate BV indicated by the first index in the first candidate list and the first identifier.

In a fourth aspect, there is provided a non-transitory storage medium having stored thereon a computer program/instructions and a bitstream, wherein when the computer program/instructions is/are executed by a processor, the computer program/instructions causes/cause the processor to to perform the method of the first aspect to generate a bitstream.

Based on the above technical solution, through introducing the first identifier and the first index, the present disclosure determines the predicted block of the current block based on the candidate BV indicated by the first index and the first identifier, thereby improving the accuracy of the predicted block, and further, decoding performance of the decoder can be improved.

### BRIEF DESCRIPTION OF THE DRAWINGS

FIG. 1 is a schematic block diagram of an encoding framework provided in an embodiment of the present disclosure.

FIG. 2 is a schematic block diagram of a decoding framework provided in an embodiment of the present disclosure.

FIG. 3 is an example of intra prediction provided in an embodiment of the present disclosure.

FIG. 4 is an example of a multiple reference line (MRL) provided in an embodiment of the present disclosure.

FIG. 5 is an example of an intra prediction mode provided in an embodiment of the present disclosure.

FIG. 6 is another example of an intra prediction mode provided in an embodiment of the present disclosure.

FIG. 7 is yet another example of an intra prediction mode provided in an embodiment of the present disclosure.

FIG. 8 is an example of a wide-angle mode provided in an embodiment of the present disclosure.

FIG. 9 is an example of a screen content provided in an embodiment of the present disclosure.

FIG. 10 is an example of template matching (TM) provided in an embodiment of the present disclosure.

FIG. 11 is an example of intra template matching prediction (intraTMP) according to an embodiment of the present application.

FIG. 12 is an example of candidate BVs in a candicate list provided in an embodiment of the present disclosure.

FIG. 13 is an example of a filter provided in an embodiment of the present disclosure.

FIG. 14 is a block diagram of training of a filtering coefficient provided in an embodiment of the present disclosure.

FIG. 15 is a schematic flowchart of a decoding method provided in an embodiment of the present disclosure.

FIG. 16 is a schematic flowchart of an encoding method provided in an embodiment of the present disclosure.

FIG. 17 is a schematic block diagram of a decoder provided in an embodiment of the present disclosure.

FIG. 18 is a schematic block diagram of an encoder provided in an embodiment of the present disclosure.

FIG. 19 is a schematic block diagram of an electronic device according to an embodiment of the present disclosure.

### DETAILED DESCRIPTION

Solutions in the embodiments of the present disclosure will be described with reference to the accompanying drawings.

The solutions provided by the embodiments of the present disclosure may be applied to the technical fields of digital video coding, which includes but is not limited to, for example, the field of picture encoding and decoding, the field of video encoding and decoding, the field of hardware video encoding and decoding, the field of dedicated circuit video encoding and decoding, and the field of real-time video encoding and decoding. In addition, the solutions provided by the embodiments of the present disclosure may be combined with an audio video coding standard (AVS), a 2nd-generation AVS (AVS2), or a 3rd-generation AVS (AVS3). Examples of the standard include but are not limited to: an H.264/audio video coding (AVC) standard, an H.265/high efficiency video coding (HEVC) standard, and an H.266/versatile video coding (VVC) standard. In addition, the solutions provided by the embodiments of the present disclosure may be used for lossy compression of pictures or lossless compression of pictures. The lossless compression may be visually lossless compression or mathematically lossless compression.

The video codec standards may adopt a block-based hybrid coding framework. A basic process of a video codec is as follows.

At the encoding side, a picture is divided into blocks, and intra prediction or inter prediction is used for a current block to generate a predicted block of the current block. The predicted block is subtracted from an original block of the current block to obtain a residual block. The residual block is transformed and quantized to obtain a quantization coefficient matrix, and the quantization coefficient matrix is entropy coded and output to a bitstream. At the decoding side, the intra prediction or the inter prediction is performed on the current block to generate the predicted block of the current block, and on the other hand, the bitstream is decoded to obtain the quantization coefficient matrix. The quantization coefficient matrix is inversely quantized and inversely transformed to obtain the residual block, and the predicted block is added to the residual block to obtain a reconstructed block. The reconstructed blocks constitute a reconstructed picture, and the reconstructed picture is loop-filtered based on the picture or block to obtain a decoded picture. Operations similar to those at the decoding side are also required at the encoding side, to obtain a decoded picture. The decoded picture may be used as a reference frame for inter prediction of subsequent frames. Mode information or parameter information determined at the encoding side, such as block division information, prediction, transform, quantization, entropy coding, in-loop filter or the like, need to be output to the bitstream if necessary. The same mode information or parameter information (such as the block division information, prediction, transform, quantization, entropy coding, in-loop filter or the like) as those of the encoding side are determined at the decoding side by decoding and analyzing according to existing information, to ensure that the decoded picture obtained at the encoding side is the same as the decoded picture obtained at the decoding side. The decoded picture obtained at the encoding side is usually referred to as the reconstructed picture. The current block may be divided into prediction units (PUs) during prediction. The current block may be divided into transform units (TUs) during transform. Division of PUs may be different from division of TUs. The above description is a basic process of the video codec in the block-based hybrid coding framework. With the development of technologies, some modules or operations in the framework or process may be optimized. The embodiments of the present disclosure are applicable to the basic process of the video codec in the block-based hybrid coding framework, but are not limited to the framework and process.

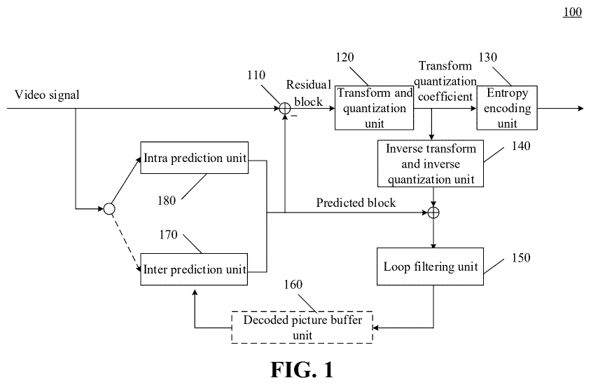

FIG. 1 is a schematic block diagram of an encoding framework 100 provided in an embodiment of the present disclosure.

As illustrated in FIG. 1, the encoding framework 100 may include an intra prediction unit 180, an inter prediction unit 170, a residual unit 110, a transform and quantization unit 120, an entropy encoding unit 130, an inverse transform and inverse quantization unit 140, and a loop filtering unit 150. Optionally, the encoding framework 100 may further include a decoded picture buffer unit 160.

The intra prediction unit 180 or the inter prediction unit 170 may predict a picture block to be encoded to output a predicted block. The residual unit 110 may calculate, based on the predicted block and the picture block to be encoded, a residual block, that is, a difference between the predicted block and the picture block to be encoded. The transform and quantization unit 120 is configured to perform operations such as transform and quantization on the residual block, to remove information insensitive to human eyes, so as to eliminate visual redundancy. Optionally, the residual block before being transformed and quantized by the transform and quantization unit 120 may be referred to as a time-domain residual block, and the time-domain residual block after being transformed and quantized by the transform and quantization unit 120 may be referred to as a frequency residual block or a frequency-domain residual block. After receiving a transform quantization coefficient output by the transform and quantization unit 120, the entropy encoding unit 130 may output a bitstream based on the transform quantization coefficient. For example, the entropy encoding unit 130 may eliminate character redundancy according to a target context model and probability information of the binary bitstream. For example, the entropy encoding unit 130 may be used for context-based adaptive binary arithmetic entropy coding (CABAC). The entropy encoding unit 130 may also be referred to as a header information encoding unit. Optionally, in the present disclosure, the picture block to be encoded may also be referred to as an original picture block or a target picture block, the predicted block may also be referred to as a predicted picture block or a picture predicted block, or may also be referred to as a predicted signal or predicted information. The reconstructed block may also be referred to as a reconstructed picture block or a picture reconstructed block, or may also be referred to as a reconstructed signal or reconstructed information. Further, for the encoding side, the picture block to be encoded may also be referred to as a coding block or a coding picture block, and for the decoding side, the picture block to be encoded may also be referred to as a decoding block or a decoding picture block. The picture block to be encoded may be a coding tree unit (CTU) or a coding unit (CU).

The encoding framework 100 performs calculation of the residual between the predicted block and the picture block to be encoded to obtain the residual block and processes the residual block through transform and quantization and so on, and then transmits the residual block to the decoding side. Accordingly, after the decoding side receives the bitstream and decodes the bitstream, the residual block is obtained through the inverse transform and inverse quantization, and the predicted block predicted by the decoding side is superimposed with the residual block to obtain the reconstructed block.

It is noted that the inverse transform and inverse quantization unit 140, the loop filtering unit 150, and the decoded picture buffer unit 160 in the encoding framework 100 may be used to form a decoder. In addition, the intra prediction unit 180 or the inter prediction unit 170 may predict the picture block to be encoded based on the reconstructed block, which can ensure that the encoding side and the decoding side have consistent understanding of the reference picture. In other words, the encoder may replicate the processing loop of the decoder, and in turn can produce the same prediction as the decoder. Specifically, the quantized transform coefficient is inversely transformed and inversely quantized by the inverse transform and inverse quantization unit 140, to replicate the approximate residual block at the decoding side. The approximate residual block plus the predicted block may pass through the loop filtering unit 150 to smoothly filter out effects such as blocking effect caused by block processing and quantization. The picture block output by the loop filtering unit 150 may be stored in the decoded picture buffer unit 160 for subsequent prediction of the picture.

It is understood that, FIG. 1 is merely an example of the present disclosure, and should not be construed as limitation of the present disclosure.

For example, the loop filtering unit 150 in the encoding framework 100 may include a deblocking filter (DBF) and a sample adaptive offset (SAO) filtering. The role of DBF is the deblocking effect, and the role of SAO is the de-ringing effect. In other embodiments of the present disclosure, the encoding framework 100 may adopt a neural network based loop filtering algorithm to improve the video compression efficiency. Alternatively, the encoding framework 100 may be a video encoding hybrid framework based on a deep learning neural network. In an implementation, on the basis of the DBF and the SAO filtering, a convolutional neural network-based model may be used for calculating a result after pixel filtering. The network structures of the loop filtering unit 150 in a luma component and a chroma component may be the same or different. Considering that the luma component contains more visual information, the luma component may also be used for guiding the filtering of the chroma component to improve reconstruction quality of the chroma component.

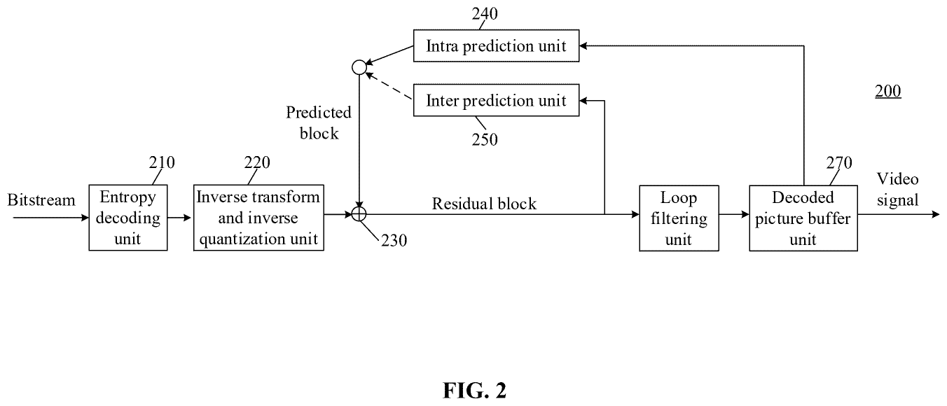

FIG. 2 is a schematic block diagram of a decoding framework 200 provided in an embodiment of the present disclosure.

As illustrated in FIG. 2, the decoding framework 200 may include an entropy decoding unit 210, an inverse transform and inverse quantization unit 220, a residual unit 230, an intra prediction unit 240, an inter prediction unit 250, a loop filtering unit 260, and a decoded picture buffer unit 270. The entropy decoding unit 210 receives and parses the bitstream to obtain a predicted block and a frequency-domain residual block. The frequency-domain residual block is inversely transformed and quantized by the inverse transformation and inverse quantization unit 220 to obtain a time-domain residual block. The residual unit 230 superimposes the predicted block obtained by the intra frame prediction unit 240 or the inter frame prediction unit 250 with the time-domain residual block after inverse transformation and inverse quantization by the inverse transformation and inverse quantization unit 220, to obtain a reconstructed block.

For convenience of understanding, the contents related to the present disclosure will be described below.

### (1) Intra Prediction

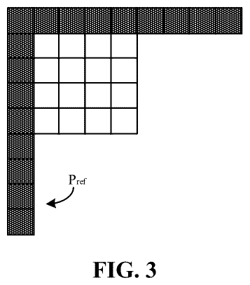

There is a strong spatial correlation between adjacent parts or adjacent pixels in a picture. The intra prediction is a prediction method that uses the spatial correlation between an encoded or decoded pixel around the current block and a pixel inside the current block. For example, as illustrated in FIG. 3, the white 4×4 block is the current block, and gray pixels in the left column and the upper row of the current block are the reference pixels of the current block, and the intra prediction uses these reference pixels to predict the current block. These reference pixels may already be all available, i.e., have been encoded or decoded. There may also be some pixels that are not available, for example, if the current block is the leftmost block of the entire picture, then the reference pixel on the left side of the current block is not available. Alternatively, when the current block is encoded or decoded and the lower left part of the current block has not been encoded or decoded, the reference pixel at the lower left in the current block is not available. In the case that the reference pixel is not available, it may be padded by the available reference pixel or a certain value or a certain method, or no padding may be performed.

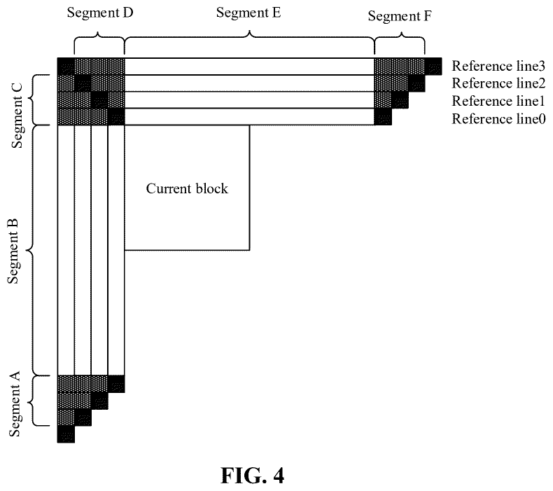

A multiple reference line (MRL) intra prediction method may use more reference pixels to improve coding efficiency. FIG. 4 is an example of an MRL provided by an embodiment of the present disclosure, and as illustrated in FIG. 4, the codec may use four reference rows/columns as reference pixels of the current block. The four reference rows/columns may be divided into Segment A to Segment F.

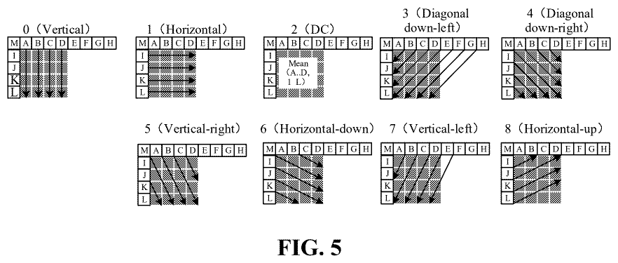

The intra prediction may have multiple prediction modes. As illustrated in FIG. 5, there are nine modes for intra prediction of the 4×4 block in H.264. In mode 0, pixels above the current block are copied to the current block in the vertical direction as the predicted values; in mode 1, the reference pixels on the left are copied to the current block in the horizontal direction as the predicted values; in mode 2 (direct current, DC), means of eight points A to D and I to L are copied as the predicted values of all points. In each of mode 3 to mode 8, the reference pixels are copied to the corresponding positions of the current block at a certain angle, because the current block at some position may not correspond exactly to a reference pixel, and it may need to use a weighted mean of the reference pixels, or called an interpolated sub-pixel of the reference pixel.

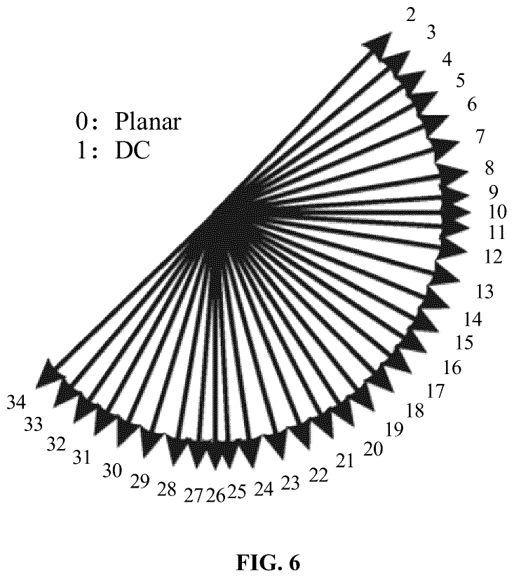

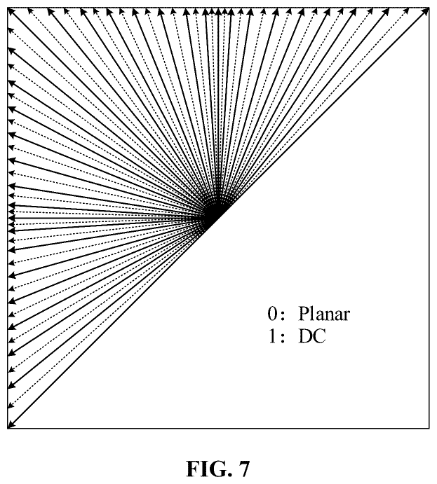

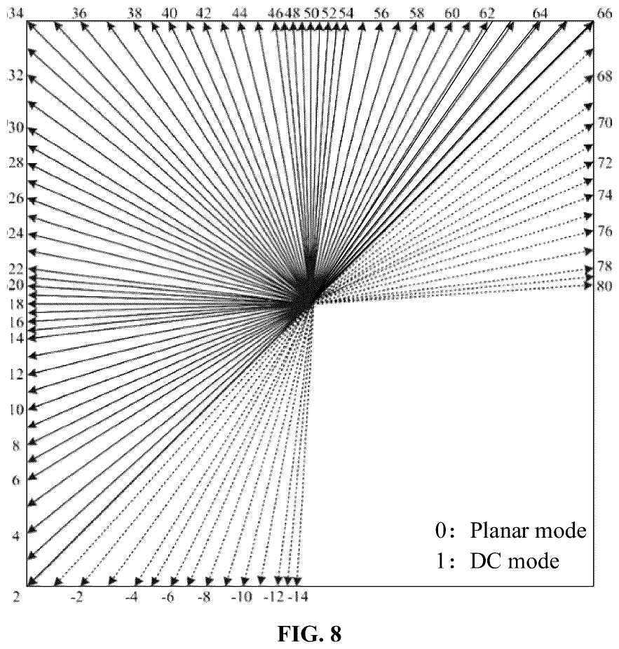

In addition, there are other modes such as Plane and Planar modes, and with the development of technologies and the expansion of blocks, there are more and more angle prediction modes. As illustrated in FIG. 6, the intra prediction used by high efficiency video coding (HEVC) may have 35 intra prediction modes including the Planar mode, the DC mode, and 33 angle modes. As illustrated in FIG. 7, the intra prediction used by versatile video coding (VVC) may have 67 intra prediction modes including the Planar mode, the DC mode, and 65 angle modes. However, in addition to the above 67 modes, the VVC also provides wide-angle modes for some rectangular blocks with a large difference between length and width, for example, as illustrated in FIG. 8, the modes indicated by dotted lines in the figure are intervals between −14 to −1 and 67 to 80, which may replace some conventional modes. In addition, AVS3 has total 66 prediction modes including the DC mode, the Plane mode, a Bilinear mode, a pulse code modulation (PCM) mode, and 62 angle modes.

### (2) Inter Prediction

A video consist of multiple pictures. Every second of the video may include dozens or even hundreds of frames of pictures, to make the video look smooth. For example, there may be 24 frames per second, 30 frames per second, 50 frames per second, 60 frames per second, 120 frames per second, and etc. Therefore, there is a very obvious temporal redundancy in the video, in other words, there are very many temporal correlations. The inter prediction uses these temporal correlations to improve the compression efficiency. The inter prediction often uses “motion” to take advantage of the temporal correlations. A very simple “motion” model is that: an object is in a certain position on a picture corresponding to a certain moment, and after a certain amount of time has passed, the object translates to another position in the picture corresponding to this moment. This is the most basic and commonly used translation motion in video codec. The inter prediction uses motion information to represent the “motion”. The basic motion information includes information of a reference frame (or reference picture) and information of a motion vector (MV). The codec determines the reference picture according to the information of the reference picture, and determines coordinates of the reference block according to the information of the MV and coordinates of the current block. The reference block is determined based on the coordinates of the reference block in the reference picture. The most basic prediction method of the inter prediction is to take the determined reference block as the predicted block.

The motion in the video is not always such a simple motion. Even the motion may be regarded as translation, the motion may have subtle changes as time passes, including subtle deformation, brightness changes, noise changes, etc. More than one reference block may be used to predict the current block, to achieve a better prediction effect. As is commonly used in bidirectional prediction, two reference blocks are used to predict the current block. One forward reference block and one backward reference block may be used as the two reference blocks. The two reference blocks may be also both the forward reference blocks or both the backward reference blocks. The term forward means that the moment corresponding to the reference picture is before that of the current frame, and the term backward means that the moment corresponding to the reference picture is after that of the current frame. In other words, the term forward means that the position of the reference picture in the video is before that of the current frame, and the term backward means that the position of the reference picture in the video is after that of the current frame. In other words, a picture order count (POC) of the forward reference picture is smaller than the POC of the current frame, and the POC of the backward reference picture is larger than the POC of the current frame. Future video codec standards may support prediction with multiple reference blocks. A simple method of generating a predicted block by using two reference blocks is to average values of the pixels corresponding to positions of the two reference blocks, to obtain the predicted block. In order to obtain a better prediction effect, a weighted average may also be used, such as the Bi-prediction with CU-level weight (BCW) currently used by VVC. A geometric partitioning mode (GPM) in VVC may also be understood as a special bidirectional prediction. In order to use the bidirectional prediction, it is necessary to find two reference blocks, such that two sets of reference picture information and motion vector information are needed.

The motion in the video is not only the simple translation, but also including zooming, rotation, distortion and various complex motions. Affine is used in the VVC to simulate some simple motions. An affine model in the VVC uses two or three control points, the motion vector of each sub-block in the current block may be derived by using the linear model according to these control points. The reason why only the motion vector is mentioned herein instead of motion information is that they all point to the same reference picture. It can be understood that the conventional translation motion is to find a “whole block” from the reference picture, while the affine is to find a group of non-contiguous “sub-blocks” from the reference picture. The above describes categories of unidirectional prediction, but the affine can also realize bidirectional prediction or prediction with more “reference blocks”. The reference block mentioned herein is composed of sub-blocks. In a specific implementation, one piece of unidirectional motion information in a data structure of affine motion information may include information of one reference picture and information of two to three motion vectors. Alternatively, one piece of unidirectional motion information may include two to three sets of information of reference pictures and information of the motion vectors, but the information of these reference pictures is the same.

### (3) Intra Block Copy (IBC)

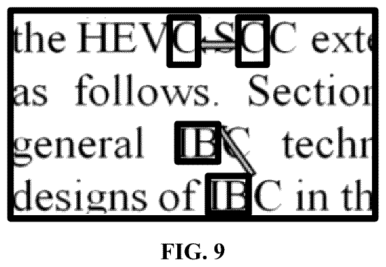

The IBC can significantly improve the compression efficiency of screen content coding, such that the IBC is used for screen content coding from HEVC to VVC. The screen content is different from camera captured content. The screen content is generated by a computer and has no noise, contains text, computer graphics, etc., and has clear boundaries. For example, as illustrated in FIG. 9, there is a large amount of repetitive contents in the screen content.

It may be considered that the IBC uses the inter prediction method into the intra prediction. As mentioned above, the inter prediction takes the reference block on the reference picture as the predicted block of the current block, and the reference picture is not the current picture. The IBC is to find a block from the encoded part or reconstructed part of the current picture as the predicted block of the current block. The IBC is also called intra picture block compensation or current picture referencing (CPR).

The IBC uses a block vector (BV) to represent a position difference between the current block and the reference block, which is similar to the MV in the inter prediction. The encoder determines the best matching block of the current block within the search range through a block matching method, and encodes the BV. There are many methods for encoding the BV, which is not elaborated herein again.

The IBC may be regarded as an intra prediction method, or may be regarded as another kind of prediction method independent of the intra prediction and inter prediction, which is not discussed herein.

### (4) Template Matching (TM)

The TM method was first used in the inter prediction, the TM method uses a correlation between adjacent pixels and uses some surrounding regions of the current block as the template. When the current block is encoded or decoded, the left and upper sides of the current block have been encoded or decoded according to the encoding order. However, when the method is implemented in the existing hardware decoder, it may not be guaranteed that when the current block starts decoding, the left and upper sides of the current block have been decoded, of course, this is the case of the inter block. For example, in HEVC, the inter-coded block does not require the surrounding reconstructed pixels when generating the predicted block, so that the prediction process of the inter block may be performed in parallel. However, the intra-coded block requires the reconstructed pixels on the left and upper sides as the reference pixels. Theoretically, the pixels on the left and upper sides are available, which means that corresponding adjustments to the hardware design can be achieved. Relatively, the pixels on the right and lower sides are not available under the encoding order of current standards such as VVC.

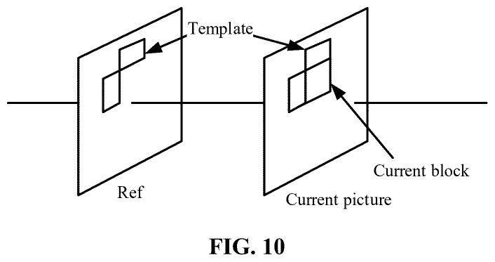

FIG. 10 is an example of TM provided in an embodiment of the present disclosure.

As illustrated in FIG. 10, rectangular regions on the left side and the upper side of the current block are set as templates, and a height of the template on the left side is generally the same as the height of the current block, and the width of the template on the upper side is generally the same as the width of the current block, but the heights or widths may also be different. The best matched position of the template is found in the reference frame, to determine the motion information or the motion vector of the current block. This process may be roughly described as: starting searching from a starting position in a certain reference frame and searching within a certain surrounding range. A search rule may be preset in advance, such as a search range, a search step size, etc. Every time the template moves to a position, a matching degree between the template corresponding to the position and the template around the current block is calculated. The matching degree may be measured by some distortion costs, such as a sum of absolute difference (SAD), a sum of absolute transformed difference (sum of absolute transformed difference, SATD), mean-square error (MSE), etc. The transform commonly used for SATD is Hadamard transform. The smaller value of the SAD, SATD, MSE, etc., the higher the matching degree. The cost is calculated based on the predicted block of the template corresponding to the position and the reconstructed block of the template surrounding the current block. In addition to the integer-pixel position search, a sub-pixel position search may be performed, and the motion information of the current block may be determined according to the searched position with the highest matching degree. With the correlation between adjacent pixels, the motion information appropriate for the template may also be the motion information appropriate for the current block. However, the template matching method may not be applicable to all blocks, therefore, some methods may be used to determine whether the above template matching method is used for the current block, for example, a control switch may be used to indicate whether the template matching method is used for the current block. A typical template matching technique is called decoder side motion vector derivation (DMVD). Both the encoder and the decoder may use the template to search, to derive the motion information or find better motion information on the basis of the original motion information. The specific motion vector or motion vector difference is not required to be transmitted, but both the encoder and the decoder may search based on the same rule to ensure the consistency of encoding and decoding. The template matching method can improve the compression performance, but it needs to perform “searching” in the decoder, which brings some complexity to the decoder.

(5) Intra Template Matching Prediction (intraTMP)

The intraTMP may be considered as a technique that combines the IBC and the TM. It is mentioned above that TM used in the inter prediction can reduce the overhead of MV coding, and similarly, the TM used in the IBC can reduce the overhead of BV coding. One example is that it is not required to encode the BV, the matching block found by the TM is directly used as the predicted block of the current block in the intraTMP mode.

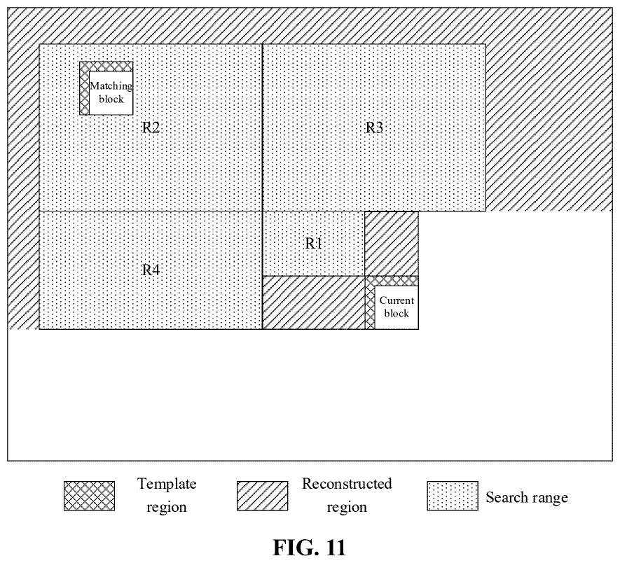

As an example of intraTMP, as illustrated in FIG. 11, the encoder (or decoder) selects the reconstructed pixels in the L-shaped region adjacent to the current coding block as templates, searches for the most similar template in the given reconstructed region of the current frame, and uses the reconstructed block corresponding to the most similar template as the matching block, which is used as the predicted block of the current coding block. For example, R1 to R4 in the figure are search regions available for the IntraTMP mode. For example, the matching block may be searched point by point in a raster scan sequence in R1 to R4.

Because an important reason why the IBC can significantly improve the compression efficiency of screen content coding is that many repeated blocks can be found in the screen content, and the screen content usually has sharp boundaries, and in terms of color (luma and chroma), there will be patches of regions of the same color (luma and chroma). However, there is almost no such situation in the camera captured content. The camera captured content inevitably has noise. Even if the color of some regions of the camera captured content is uniform superficially, the luma and chroma of a region may usually be different from that of another region to some extent, and the camera captured content rarely has sharp boundaries. On the other hand, the camera captured content may have approximately repeated blocks, and the term approximately repeated means that it is difficult to find the exact same blocks due to noise, subtle changes in luma, perspective angle, etc. But it is not denied that that repeated textures may be present in the camera captured content.

Generally, the intraTMP may take the best matching block found by the template matching as the final predicted block. When decoding the current block, generally, there may be a flag bit for determining whether the current block uses the intraTMP. If the current block uses intraTMP, the decoder may find the best matching block by using the TM method, and take a value of the best matching block as the predicted value of the current block. It is noted that, although the template has a strong correlation with the current block, the template is not the current block in essence, and the best matching block (actually the position of the current block corresponding to the best matching block of the template) found based on the template may not necessarily be the best matching block of the current block. However, there is no current block when the decoder performs searching, therefore, only the best matching block found based on the template may be taken as the best matching block found by the intraTMP.

(6) IntraTMP with Multiple Candidates

N candidates are set for intraTMP, or a candidate list intraTmpCandList[N] of length N may be set. During the encoding process, if the current block uses the intraTMP, after the flag bit is encoded, an index needs to be encoded to determine the candidate selected for the current block from the N candidates. Accordingly, the syntax of decoding is illustrated as follows, where intra_tmp_flag is the flag of intraTMP. If intra_tmp_flag is true, intra_tmp_idx is parsed, intra_tmp_idx represents the index of the selected candidate.

intra_tmp_flag
If (intra_tmp_flag)
{
intra_tmp_idx
}.

The decoder sets the block corresponding tointraTmpCandList[intra_tmp_idx] as the block selected for the intraTMP. In other words, the decoder sets the BV corresponding to intraTmpCandList[intra_tmp_idx] as the BV selected for intraTMP.

For the operation of building intraTmpCandList, an example is described as follows.

Since in intraTMP, a cost on the template may be calculated under the BV for every searched BV. The cost on the template may generally be a cost of matching the template of the current block with the template of a block, with the same size as the current block, determined by the current BV. The cost may be SAD, SATD, SSE, etc. IntraTMP may sort the searched blocks or searched BVs in an ascending order according to these costs, and the top N candidates are the N candidates of intraTmpCandList. Optionally, only the top N candidates with the lowest costs are maintained, and the candidates ranked after N may be directly discarded, to Save the Amount of Calculation.

Generally, blocks corresponding to adjacent BVs are relatively close to each other, especially if the BV supports sub-pixel precision, such as ½, ¼, ⅛, 1/16 precision, etc. Therefore, if the candidates are only sorted according to the costs on the templates without any limitation, it is easy to concentrate the multiple candidates into a small range. Thus some limitations need to be made to avoid excessive concentration of the candidate BVs in intraTmpCandList.

One approach is described as follows.

In the searching process, not all possible BVs are searched in sequence. For example, a conventional search order is from left to right and from top to bottom. Generally, the integer-pixel BVs may be searched in sequence. If the currently searched BV is (x0, y0), then the next one is (x0+1, y0), provided the boundary of the search range is not reached. Herein, a sparse search may be performed first, for example, for the integer-pixel BV, if the currently searched BV is (x0, y0), then the next one is (x0+4, y0), provided the boundary of the search range is not reached. That is, the template matching is performed every certain number of pixels, in other words, the template matching may be performed every certain step size. The step size may be a preset value, such as 2, 4, 8, etc. Similarly, the same processing may be performed in the vertical direction. First, N BVs with the lowest costs may be found, then, on the basis of the N BVs with the lowest costs, the improvement is carried out in a small range based on each BV. If the above search interval is 4 pixels, then the improved range may be set to 4×4, and the improved BV may replace the original BV and be re-sorted among N candidates. In such way, N BV candidates with a certain distance may be obtained.

For example, if N is 3, the following manners may be performed for improvement.

### First Operation

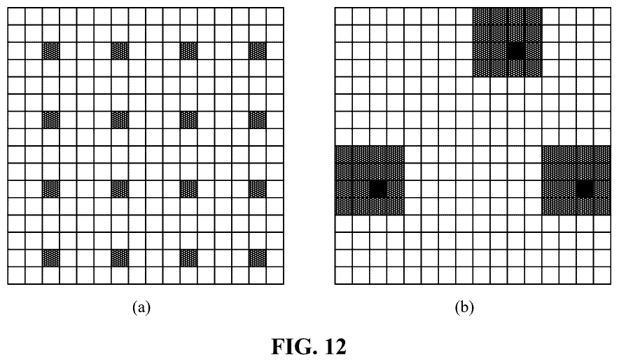

As illustrated in (a) of FIG. 12, the first search is performed according to a preset step size, and an upper left corner of the searched block is illustrated as a gray dot. As illustrated in (b) of FIG. 12, three sorted BVs are found, and the upper left corner of the corresponding block is illustrated as a black dot. The step size in the horizontal direction is 4, and the step size in the vertical direction is 4.

### Second Operation

The second search is performed on the basis of the three sorted BVs. The current search range is 4×4, as illustrated by the green dot in the figure. In all the 4×4 BVs, the BV with the lowest cost is found to replace the original BV and is used for re-sorting intraTmpCandList. However, if the BV with the lowest cost is still the original BV, the re-sorting is not needed.

If the sub-pixel precision is supported, refinement may be continued for the sub-pixel BV. For example, on the basis of the integer-pixel BV selected in the second operation, ½ pixel search is performed within one pixel range above, below, left, and right of the integer-pixel BV.

It is noted that the candidate list is built in both the encoding side and the decoding side, so as to ensure that the candidate list obtained by the encoding side and the candidate list obtained by the decoding side are consistent.

### (7) Binarization Method of Intra_Tmp_Idx.

Because intraTmpCandList is sorted, statistically, candidates positioned earlier in the intraTmpCandList have higher probabilities of being selected. Therefore, variable-length coding may be set for binarization and de-binarization of intra_tmp_idx, or a truncated unary may be used. The variable-length coding manner is illustrated in the following Table 1.

TABLE 1

| | |
|---|---|
| intra_tmp_idx | Binary symbol |

| | | |
|---|---|---|
| 0 | 1 | |
| 1 | 0 | 1 |
| 2 | 0 | 0 |
| Bin index | 0 | 1 |

However, if the probabilities of being selected are similar, the fixed-length coding or truncated binary may also be used.

If N is relatively large, the probabilities of being selected of the candidates at the front are large, the probabilities of the candidates at the back are smaller, while those further back have progressively similar probabilities. Therefore, the codeword for the candidate at the front may be shorter than the codeword for the candidate at the back, and some candidates at the back may share the same codeword length. For example, the coding may be performed in the manner as illustrated in Table 2.

TABLE 2

| Intra_tmp_idx | Binary symbol | | | | |
|---|---|---|---|---|---|
| 0 | 1 | 1 | | | |
| 1 | 1 | 0 | 0 | | |
| 2 | 1 | 0 | 1 | | |
| 3~6 | 0 | x | x | x | |
| 7~14 | 0 | x | x | x | x |

As illustrated in Table 2, assuming that N is 15, indices 3 to 6 share the codeword with the same length, and indices 7 to 14 share the codeword with the same length, x in the above table may be obtained by the truncated binary.

### (8) IntraTMP Filtering

In the above intraTMP method, the predicted block is directly generated by using the reference block. In other words, if the determined BV has the integer-pixel precision, a value in the position corresponding to the reference block is directly taken as a value in the position corresponding the predicted block. If the determined BV has the sub-pixel precision, a value in the corresponding position obtained by interpolation filtering is directly taken as the value in the position corresponding to the predicted block. After the predicted block is directly generated, a filtering process on the predicted value may continue to be performed to improve the predicted block.

A block-level flag bit may be used for indicating whether the current block uses the filtering process.

The filter may have a variety of forms. A possible form of the filter is illustrated as follows:

$$predC = c 0 C + c 1 N + c 2 S + c 3 E + c 4 W + c 5 B .$$

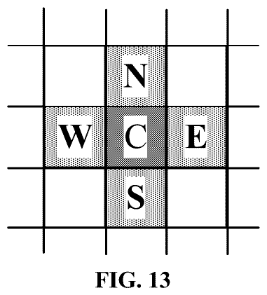

Herein, the filter uses the pixel to be filtered and the adjacent upper, lower, left and right pixels of the pixel to be filtered, to form a cross shape, as illustrated in FIG. 13. C is the pixel to be filtered, N is the pixel on the upper side, S is the pixel on the lower side, W is the pixel on the left side, E is the pixel on the right side, and B (bias) is a fixed value. An example is that B is a median value in a range of pixel values, i.e., if the pixel value is the maximum value of 1023 of a 10-bit, then B is set to 512. c0, c1, c2, c3, c4, c5 are coefficients of the filter.

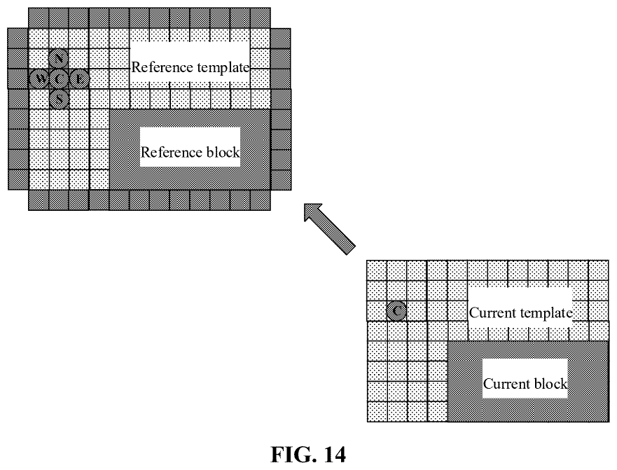

Furthermore, a method of determining the coefficients of the filter is to train the coefficients of the filter by using the template of the reference block and the template of the current block. An example is illustrated in FIG. 14. If intraTMP uses a template with an upper height of 4 and a left width of 4, then the template for training the filter may also have the same size, and the region beyond the reference block template may be supplemented from the template of the reference block by padding, so that the additional bandwidth is not required.

In addition, a method of training the coefficients of the filter is to calculate a set of coefficients so as to minimize the mean square error (MSE) of the filtered template of the reference block and the template of the current block.

If the current block uses the intraTMP filtering to filter the predicted block directly derived from the reference block, a method is to filter each pixel sequentially from left to right and top to bottom. The filtered value is taken as predicted value.

It is noted that the method of intraTMP with multiple candidates uses the template to filter a small number of promising candidates from a large number of possible BVs, and then the encoder selects a candidate to determine the reference block or the predicted block of the current block. The template may effectively filter out most of the unreasonable BVs by utilizing the correlation between the current block and the template. On the other hand, the encoder may access the original pixel value of the current block, such that the encoder can make a more accurate determination than the decoder. In this way, the better compression efficiency can be achieved by using the cooperation of encoder and decoder. The intraTMP filtering may use the template to train the coefficients of the filter and make improvement on the original predicted value of the intraTMP.

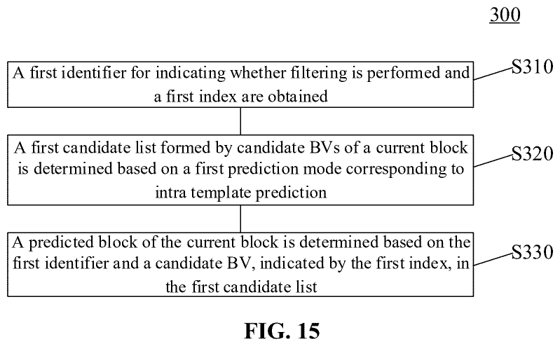

FIG. 15 is a schematic flowchart of a decoding method 300 provided in an embodiment of the present disclosure. It should be understood that the decoding method 300 may be performed by a decoder. For example, the decoding method may be applied to the decoding framework 200 illustrated in FIG. 2. For convenience of description, the encoder will be described below as an example.

As illustrated in FIG. 15, the decoding method 300 includes some or all of the following operations.

At S310, a decoder obtains a first identifier for indicating whether filtering is performed and a first index.

Illustratively, the first identifier may be a sequence-level identifier, a picture-level (i.e., a frame-level) identifier, a slice-level identifier, or a picture block-level identifier.

At S320, the decoder determines a first candidate list formed by candidate BVs of a current block based on a first prediction mode corresponding to intra template prediction.

Illustratively, the first prediction mode may be the intraTMP mode mentioned above.

At S330, the decoder determines a predicted block of the current block based on a candidate BV indicated by the first index in the first candidate list and the first identifier.

In the embodiment, through introducing the first identifier and the first index, the predicted block of the current block is determined based on the candidate BV indicated by the first index and the first identifier, thereby improving the accuracy of the predicted block, and further, the decoding performance of the decoder can be improved.

In some embodiments, the operation S310 may include the following operations.

A second identifier is obtained.

The first identifier and the first index are obtained when the second identifier indicates that the current block is predicted by using the first prediction mode.

Illustratively, the decoder decodes the bitstream to obtain the second identifier, and if the second identifier indicates that the prediction is performed by using the first prediction mode, the decoder decodes the bitstream to obtain the first identifier and the first index. Otherwise, the decoder employs another prediction mode to obtain the predicted block. The second identifier may be a sequence-level identifier, a picture-level (i.e., a frame-level) identifier, a slice-level identifier, or a picture block-level identifier.

Illustratively, when a value of the second identifier is 0, which indicates that the first prediction mode is used for prediction, and when the value of the second identifier is 1, which indicates that the first prediction mode is not used for prediction. Alternatively, when the value of the second identifier is 1, which indicates that the first prediction mode is used for prediction, and when the value of the second identifier is 0, which indicates that the first prediction mode is not used for prediction. However, other values may be used for indication, which is not limited in the present disclosure.

Of course, the corresponding indication function may be realized by the second by other means, which is not limited in the present disclosure.

For example, when the value of the second identifier is “true”, it indicates that first prediction mode is used for prediction, and when the value of the second identifier is “false”, it indicates that the first prediction mode is not used for prediction.

In some embodiments, the operation S320 may include the following operations.

The decoder performs template matching on the current block based on the first prediction mode firstly, to obtain a plurality of candidate BVs; and then the decoder determines the first candidate list based on the plurality of candidate BVs.

Illustratively, when the decoder performs the template matching on the current block based on the first prediction mode, the decoder may perform the template matching on the current block according to a preset parameter (e.g., at least one of a search range, a search step size, a search order, and a number of candidate BVs in the first candidate list) to obtain the plurality of candidate BVs; the decoder may also perform the template matching on the current block according to a parameter corresponding to the first identifier (e.g., at least one of a search range, a search step size, a search order, and a number of candidate BVs in the first candidate list) to obtain the plurality of candidate BVs.

Illustratively, when the decoder determines the first candidate list based on the plurality of candidate BVs, the decoder may construct the first candidate list based on the plurality of candidate BVs according to a preset construction method, or may construct the first candidate list based on the plurality of candidate BVs according to a construction method corresponding to the first identifier.

It is noted that, because the decoder may perform the template matching on the current block according to the parameter (e.g., at least one of the search range, the search step size, the search order, and the number of candidate BVs in the first candidate list) corresponding to the first identifier to obtain the plurality of candidate BVs, and the decoder may construct the first candidate list based on the plurality of candidate BVs according to the construction method corresponding to the first identifier, in such a way, the first candidate list determined by the decoder when the first identifier indicates that the filtering is performed is different from the first candidate list determined by the decoder when the first identifier indicates that the filtering is not performed.

In some embodiments, the decoder performs, based on the first prediction mode, the template matching on the current block according to a parameter corresponding to the first identifier, to obtain the plurality of candidate BVs.

In other words, different values of the first identifier correspond to different parameters.

In the embodiment, when the decoder performs the template matching on the current block based on the first prediction mode in consideration of the first identifier, the decoder performs the template matching on the current block according to the parameter corresponding to the first identifier, to obtain the plurality of candidate BVs. In such a way, it is ensured that the first candidate list used by the decoder is a candidate list adapted to the first identifier, thereby improving the decoding performance of the decoder.

However, in other alternative embodiments, different values of the first identifier may correspond to the same parameter. For example, regardless of the value of the first identifier, the decoder may perform the template matching on the current block according to the preset parameter to obtain the plurality of candidate BVs.

In some embodiments, the parameter corresponding to the first identifier may include at least one of: a search range, a search step size, a search order, or a number of the candidate BVs in the first candidate list.

However, in other alternative embodiments, the parameter corresponding to the first identifier may also include another parameter used for the decoder to perform the template matching, which is not limited in the present disclosure.

In some embodiments, the parameter corresponding to the first identifier includes a first search range when the first identifier indicates that the filtering is performed; and the parameter corresponding to the first identifier includes a second search range when the first identifier indicates that the filtering is not performed. The first search range is smaller than the second search range.

In other words, different values of the first identifier correspond to different search ranges.

Illustratively, if the first identifier indicates that the filtering is performed, the decoder performs the template matching on the current block according to the first search range based on the first prediction mode, to obtain a plurality of candidate BVs in the first search range, and determines the first candidate list based on the plurality of candidate BVs in the first search range. If the first identifier indicates that that the filtering is not performed, the decoder performs the template matching on the current block according to the second search range based on the first prediction mode, to obtain a plurality of candidate BVs in the second search range, and then determines the first candidate list based on the plurality of candidate BVs in the second search range. The first search range may be a search range smaller than the second search range.

Similarly, different values of the first identifier may correspond to different search step sizes, different search orders, or different numbers of candidate BVs.

For example, the parameter corresponding to the first identifier includes a first search step size when the first identifier indicates that the filtering is performed; and the parameter corresponding to the first identifier includes a second search step size when the first identifier indicates that the filtering is not performed. The first search step size is larger than the second search step size.

As another example, the parameter corresponding to the first identifier includes a first search order when the first identifier indicates that the filtering is performed; and the parameter corresponding to the first identifier includes a second search order when the first identifier indicates that the filtering is not performed. The first search order is different from the second search order.

As yet another example, the number of the candidate BVs in the first candidate list is a first number when the first identifier indicates that the filtering is performed; and the number of the candidate BVs in the first candidate list is a second number when the first identifier indicates that the filtering is performed. The first number is smaller than the second number.

Specifically, in the above embodiments, the first search range is smaller than the second search range, the first search step size is larger than the second search step size, and the first number is smaller than the second number, all of these restrictions are to ensure that the number of candidate BVs in the first candidate list constructed by the decoder when the first identifier indicates the filtering is performed is smaller than the number of candidate BVs in the first candidate list constructed by the decoder when the first identifier indicates the filtering is not performed, which can reduce the complexity for the decoder to construct the first candidate list when the first identifier indicates that the filtering is performed, but it is not limited in the present disclosure. However, in other alternative embodiments, the first search range may also be greater than or equal to the second search range, similarly, the first search step size may also be less than or equal to the second search step size, and the first number may also be greater than or equal to the second number, which is not specifically limited in the present disclosure.

In some embodiments, the decoder determines template matching costs for the plurality of candidate BVs; and the decoder sorts the plurality of candidate BVs based on the template matching costs for the plurality of candidate BVs, to obtain the first candidate list.

In the embodiment, the decoder determines the first candidate list based on the plurality of candidate BVs without considering the first identifier. Further, since there are two cases in which the first identifier is considered or not considered when the decoder performs the template matching based on the first prediction mode, the schemes for the decoder to determine the first candidate list may include any of the following first scheme and second scheme.

### First Scheme

The decoder performs the template matching on the current block according to the preset parameter (e.g., at least one of the search range, the search step size, the search order, or the number of candidate BVs in the first candidate list) to obtain the plurality of candidate BVs. Then the decoder sorts the plurality of candidate BVs based on the template matching costs for the plurality of candidate BVs, to obtain the first candidate list.

For example, taking the preset parameter including the search range as an example, regardless of whether the first identifier indicates the filtering is performed or not, the decoder performs the template matching on the current block according to the preset search range to obtain a plurality of candidate BVs within the preset search range, and then the decoder sorts the plurality of candidate BVs within the preset search range based on the template matching costs for the plurality of candidate BVs within the preset search range to obtain the first candidate list.

### Second Scheme

The decoder performs the template matching on the current block according to the parameter (e.g., at least one of the search range, the search step size, the search order, or the number of candidate BVs in the first candidate list) corresponding to the first identifier to obtain the plurality of candidate BVs. Then the decoder sorts the plurality of candidate BVs based on the template matching costs for the plurality of candidate BVs, to obtain the first candidate list.

For example, taking the parameter corresponding to the first identifier including the search range as an example, when the first identifier indicates the filtering is performed, the decoder performs the template matching on the current block according to a first search range to obtain a plurality of candidate BVs within the first search range, and then the decoder sorts the plurality of candidate BVs within the first search range based on the template matching costs for the plurality of candidate BVs within the first search range to obtain the first candidate list. When the first identifier indicates the filtering is not performed, the decoder performs the template matching on the current block according to a second search range to obtain a plurality of candidate BVs within the second search range, and then the decoder sorts the plurality of candidate BVs within the second search range based on the template matching costs for the plurality of candidate BVs within the second search range to obtain the first candidate list. The first search range is smaller than the second search range.

Illustratively, the decoder may determine the first candidate list according to the first scheme or the second scheme by default.

In some embodiments, the decoder determines the first candidate list based on the plurality of candidate BVs and the first identifier.

Illustratively, the decoder determines the first candidate list based on the plurality of candidate BVs by using a construction method corresponding to the first identifier.

In other words, different values of the first identifier correspond to different construction methods for the first candidate list.

In some embodiments, if the first identifier indicates that the filtering is performed, the template matching costs for the plurality of candidate BVs are determined; at least one candidate BV from the plurality of candidate BVs is determined based on the template matching costs for the plurality of candidate BVs; filtering on a template corresponding to a candidate BV in the at least one candidate BV is performed to obtain a filtered template corresponding to the candidate BV in the at least one candidate BV; a template matching cost for the candidate BV in the at least one candidate BV is determined based on the filtered template corresponding to the candidate BV in the at least one candidate BV and a template of the current block; and the at least one candidate BV is sorted based on the template matching cost for the candidate BV in the at least one candidate BV, to obtain the first candidate list.

Illustratively, the template matching costs for the plurality of candidate BVs include a template matching cost for each candidate BV of the plurality of candidate BVs, and the template matching cost for each candidate BV is a matching cost between a template of a reference block corresponding to the candidate BV and a template of the current block. The matching cost may be any parameter that may be used for measuring a distortion cost, which includes but not limited to, an SAD, an SATD, an MSE, etc.

Illustratively, when the decoder performs the filtering on the template corresponding to a first candidate BV of the at least one candidate BV, the decoder may first determine a coefficient of the filter based on the template of the reference block corresponding to the first candidate BV and the template of the current block. Then the decoder may perform filtering on the template of the reference block corresponding to the first candidate BV based on the determined coefficient of the filter to obtain a filtered template corresponding to the first candidate BV. Further, the decoder may determine the matching cost for the first candidate BV based on the filtered template corresponding to the first candidate BV and the template of the current block.

Illustratively, when the decoder sorts the at least one candidate BV based on the template matching cost for the candidate BV in the at least one candidate BV, the decoder may sort the at least one candidate BV in an ascending order to obtain the first candidate list.

In other words, if the first identifier indicates that the filtering is performed, the decoder may determine the first candidate list according to the following first construction method. The first construction method may include the following operations: the template matching costs for the plurality of candidate BVs are determined; at least one candidate BV is determined from the plurality of candidate BVs based on the template matching costs for the plurality of candidate BVs; filtering on a template corresponding to a candidate BV in the at least one candidate BV is performed to obtain a filtered template corresponding to the candidate BV in the at least one candidate BV; a template matching cost for the candidate BV in the at least one candidate BV is determined based on the filtered template corresponding to the candidate BV in the at least one candidate BV and a template of the current block; and the at least one candidate BV is sorted based on the template matching cost for the candidate BV in the at least one candidate BV, to obtain the first candidate list.

In some embodiments, the decoder sorts the plurality of candidate BVs based on the template matching costs for the plurality of candidate BVs; and determines a portion of the plurality of sorted candidate BVs that is at a top position as the at least one candidate BV.

Illustratively, the decoder sorts the plurality of candidate BVs in an ascending order based on the template matching costs for the plurality of candidate BVs; and then determines some of the sorted candidate BVs that is at a top position as the at least one candidate BV.

In some embodiments, the template matching costs for the plurality of candidate BVs are determined when the first identifier indicates that the filtering is not performed; and the plurality of candidate BVs are sorted based on the template matching costs for the plurality of candidate BVs, to obtain the first candidate list.

In other words, if the first identifier indicates that the filtering is not performed, the decoder may determine the first candidate list according to the following second construction method. The second construction method may include the following operations: the plurality of candidate BVs are sorted in an ascending order based on the template matching costs for the plurality of candidate BVs; and then some of the sorted candidate BVs that is at a top position is determined as the at least one candidate BV.

In the embodiment, when the decoder determines the first candidate list based on the plurality of candidate BVs, the first candidate list is determined based on the plurality of candidate BVs and the first identifier. Since there are two cases in which the first identifier is considered or not considered when the decoder performs the template matching based on the first prediction mode, the schemes for the decoder to determine the first candidate list may include any of the following first scheme and second scheme.

### First Scheme

The decoder performs the template matching on the current block according to the preset parameter (e.g., at least one of the search range, the search step size, the search order, or the number of candidate BVs in the first candidate list) to obtain the plurality of candidate BVs. Then the decoder constructs, based on the plurality of candidate BVs, the first candidate list according to the construction method corresponding to the first identifier (such as the first construction method or second construction method).

For example, the decoder performs the template matching on the current block according to the preset parameter (e.g., at least one of the search range, the search step size, the search order, or the number of candidate BVs in the first candidate list) to obtain the plurality of candidate BVs. If the first identifier indicates that the filtering is performed, the decoder constructs, based on the plurality of candidate BVs, the first candidate list according to the first construction method; and if the first identifier indicates that the filtering is not performed, the decoder constructs, based on the plurality of candidate BVs, the first candidate list according to the second construction method.

### Second Scheme

The decoder performs the template matching on the current block according to the parameter (e.g., at least one of the search range, the search step size, the search order, or the number of candidate BVs in the first candidate list) corresponding to the first identifier to obtain the plurality of candidate BVs. Then the decoder constructs, based on the plurality of candidate BVs, the first candidate list according to the construction method corresponding to the first identifier (such as the first construction method or second construction method).

For example, taking the parameter corresponding to the first identifier including the search range as an example, if the first identifier indicates that the filtering is performed, the decoder performs the template matching on the current block according to the first search range, to obtain a plurality of candidate BVs within the first search range; and then the decoder determines, based on the plurality of candidate BVs within the first search range, the first candidate list according to the first construction method. If the first identifier indicates that that the filtering is not performed, the decoder performs the template matching on the current block according to the second search range, to obtain a plurality of candidate BVs within the second search range; and then the decoder determines, based on the plurality of candidate BVs within the second search range, the first candidate list according to the second construction method. The first search range may be smaller than the second search range.

In some embodiments, the operation S310 may include the following operations.

The first identifier is obtained.

The first index is obtained based on the first identifier.

Illustratively, the decoder first decodes the bitstream to obtain the first identifier, and then decodes the bitstream based on the first identifier to obtain the first index.

However, in other alternative embodiments, the first index may be decoded without depending on decoding of the first identifier. For example, the decoder may obtain the first identifier and the first index simultaneously by decoding the bitstream, or the decoder may obtain the first index by decoding the bitstream first and then obtain the first identifier by decoding the bitstream.

In some embodiments, the first index is obtained based on a de-binarization method corresponding to the first identifier.

In other words, different values of the first identifier correspond to different de-binarization methods.

In some embodiments, when the first identifier indicates that the filtering is not performed, the de-binarization method corresponding to the first identifier includes at least one of a variable-length code binarization method or a truncated unary binarization method; and when the first identifier indicates that the filtering is performed, the de-binarization method corresponding to the first identifier includes at least one of a fixed-length code binarization method or a truncated binary binarization method.

Illustratively, if the first identifier indicates that the filtering is not performed, the decoder may follow the de-binarization method as illustrated in Table 3 below:

TABLE 3

| First index | BinIdx0 | BinIdx1 | BinIdx2 |
|---|---|---|---|
| 0 | 1 | | |
| 1 | 0 | 1 | |
| 2 | 0 | 0 | 1 |
| 3 | 0 | 0 | 0 |

As illustrated in Table 3, the smaller the value of the first index, the shorter the length of the binarized binary sequence. BinIdx0, BinIdx1, and BinIdx2 identify the first binary bit, the second binary bit, and the third binary bit, respectively.

Illustratively, if the first identifier indicates that the filtering is performed, the decoder may follow the de-binarization method as illustrated in Table 4 below:

TABLE 4

| First index | BinIdx0 | BinIdx1 |
|---|---|---|
| 0 | 0 | 0 |
| 1 | 0 | 1 |
| 2 | 1 | 0 |
| 3 | 1 | 1 |

As illustrated in Table 4, regardless the value of the first index, the length of the binarized binary sequence is fixed to 2. BinIdx0 and BinIdx1 identify the first binary bit and the second binary bit, respectively.

In some embodiments, the decoder obtains the first index based on a context model corresponding to the first identifier.

In other words, different values of the first identifier correspond to different context models.

In some embodiments, the operation S330 may include the following operations.

Filtering on a reference block corresponding to the candidate BV indicated by the first index is performed to obtain the predicted block when the first identifier indicates that the filtering is performed.

The reference block corresponding to the candidate BV indicated by the first index is determined as the predicted block when the first identifier indicates that the filtering is not performed.

It is noted that the operation that the decoder performs filtering on the reference block corresponding to the candidate BV indicated by the first index to obtain the predicted block may also be understood as that: the decoder performs filtering on a first predicted block corresponding to the candidate BV indicated by the first index to obtain a second predicted block. Alternatively, the operation may also be understood as that: the decoder first determines the reference block corresponding to the candidate BV indicated by the first index as the first predicted block of the current block, and then performs filtering on the first predicted block to obtain the second predicted block. In other words, for the decoder, the technical solution of filtering the reference block corresponding to the candidate BV indicated by the first index and the technical solution of filtering the predicted block of the current block are essentially the same, and the difference is that the aspect in which the filtering is described is different.

In some embodiments, the method 300 may further include the following operations.

A residual block of the current block is obtained.

A reconstructed block of the current block is determined based on the residual block and the predicted block.

The decoder obtains the reference block by decoding the bitstream, and determines the reconstructed block based on the residual block and the predicted block. For example, the decoder may determine a sum of the residual block and the predicted block as the reconstructed block.

In some embodiments, the method 300 may further include the following operations.

A first template region of a reference block corresponding to the candidate BV indicated by the first index and a second template region of the current block are obtained when the first identifier indicates that the filtering is performed.

A filtering coefficient is determined based on the first template region and the second template region.

Illustratively, if the first identifier indicates that the filtering is performed, the decoder obtains the first template region and the second template region, and determines the filtering coefficient based on the first template region and the second template region. Then the decoder performs the filtering on the reference block corresponding to the candidate BV indicated by the first index to obtain the predicted block.

In some embodiments, the decoder may determine the filtering coefficient in the following manners.

For a first sample in the first template region, filtering on the first sample is performed with a sample in a surrounding region of the first sample, to obtain a filtered second sample.

The filtering coefficient is determined based on a difference between the second sample and a third sample in the second template region. A position of the first sample in the first template region is the same as a position of the third sample in the template region.

Illustratively, the decoder may perform filtering on each sample in the first template region to obtain a filtered sample within the first template region, and then determine the filtering coefficient based on a difference between the filtered sample within the first template region and the sample in the second template region. For example, the decoder may determine the filtering coefficient based on an MSE between the filtered sample in the first template region and the sample in the second template region. For example, the decoder may adjust a current coefficient used by the filter based on the MSE between the filtered sample in the first template region and the sample in the second template region, and determine the current coefficient as the filter coefficient until the MSE between the filtered sample in the first template region and the sample in the second template region is less than a preset threshold value or until the number of adjustments is greater than a preset number.

In some embodiments, when the sample in the surrounding region of the first sample includes a sample at a first position outside the first template region, the sample at the first position is a sample obtained by padding the first position with a sample in the first template region.

Illustratively, the first position is a position adjacent to a sample side in an edge position of the first template region. For example, the first position is a position adjacent to an upper edge of the first template region, a position adjacent to a lower edge of the first template region, a position adjacent to a left edge of the first template region, or a position adjacent to a right edge of the first template region. For example, as illustrated in FIG. 14, the first template region is a reference template, the second template region is a current template, and the first sample is a sample at the upper left corner position of the reference template, the sample at the first position may include the upper sample and left sample of the sample at the upper left corner position of the reference template.

In some embodiments, the filtering coefficient is a coefficient obtained by training.

However, in other alternative embodiments, the filtering coefficient may also be determined by performing calculation on the samples in the first template region and the sample in the second template region, which is not limited in the present disclosure.

It should be noted that the first template region and the second template region may refer to FIG. 14 and the related contents of the intraTMP filter portion described above, which will not be elaborated herein again to avoid repeating. In addition, in other alternative embodiments, the method of determining the filtering coefficient may also be simplified. For example, in a possible implementation, the data (i.e., the first template region and the second template region) used for determining the filtering coefficient may be simplified. For example, compared to the template region illustrated in FIG. 14, a template region of three rows and three columns may be used. As another example, in another possible implementation, the method of determining the filtering coefficient may be simplified based on the training method, for example, a training method simpler than MSE may be used to train the filtering coefficient, which is not specifically limited in the present disclosure.

Specific embodiments will be described below.

### First Embodiment

The syntax of the decoder is described as follows:

intra_tmp_flag
if (intra_tmp_flag)
{
intra_tmp_idx
intra_tmp_filter_flag
}.

The specific process of the decoder is described as follows.

If the current block determines the predicted value by using the intraTMP technique, then:
1. intra_tmp_idx and intra_tmp_filter_flag are parsed, which are independent of each other, and the parsing order may be reversed;
2. possible BVs are searched in a preset search range according to a preset search method, template matching costs for the searched BVs are calculated according to templates corresponding to the searched BVs and the template of the current block, and a candidate list intraTmpCandList is determined according to the template matching costs;
3. a BV selected for the current block is determined according to the candidates in intraTmpCandList[intra_tmp_idx], and then the reference block is determined; and
4. if a value of intra_tmp_filter_flag is 1 or true, the reference block is filtered. A method is to determine a reference block template according to the selected BV, and to determine the filtering coefficient according to the reference block template and the current block template. The reference block is filtered according to the determined filtering coefficient. A value of a position corresponding to the filtered reference block is taken as a value of a position corresponding to the predicted block. If the value of intra_tmp_filter_flag is 0 or false, the value of the position corresponding to the reference block is used as the value of the position corresponding to the predicted block.

The specific process in the encoder is described as follows:
1. the candidate list intraTmpCandList is constructed in the same way as the operation 2 of the decoder;
2. the values of intra_tmp_idx and intra_tmp_filter_flag are determined, the predicted value of intraTMP is determined, and the coding cost of using intraTMP is determined; and
3. whether the current block uses intraTMP is determined according to the coding cost of intraTMP, and if the current block uses intraTMP, the values of intra_tmp_idx and intra_tmp_filter_flag are encoded and written into the bitstream.

The specific method of operation 2 is described as follows.

A BV is determined according to each candidate in intraTmpCandList; a reference block corresponding to the BV is determined to obtain a predicted block that is not filtered; a reference block template is determined; a filtering coefficient is determined according to the reference block template and a current block template; a predicted block that is filtered is determined according to the filtering coefficient and the reference block; the distortion cost SAD or SATD is estimated according to comparison of the predicted block that is not filtered corresponding to each candidate and the current block and comparison of the predicted block that is filtered corresponding to each candidate and the current block; a coding cost is estimated by adding the estimated distortion cost SAD or SATD and the estimated overhead cost; and several combinations of candidates and filtering are selected according to the estimated coding costs to perform rate distortion optimization (RDO) to determine a coding cost. The pseudo code is described as follows:

```
  for (intra_tmp_idx = 0; intra_tmp_idx < N; intra_tmp_idx + +) {
    Prediction
  for (intra_tmp_filter_flag = 0; intra_tmp_filter_flag < 2;
intra_tmp_fusion_flag + +) {
    if (intra_tmp_filter) {filter prediction}
  }
  Calculate cost
  }.
```

However, the RDO may not be performed and the estimated coding cost may be used as the coding cost. This method is generally used in case where the coding complexity is limited.

Of course, the encoder may also be simplified. In the above example, each candidate with filtering or without filtering will be checked. Alternatively, all candidates without filtering may be checked first, and one or more best candidates with filtering may be selected to check. The pseudo code is described as follows:

```
  for (intra_tmp_idx = 0; intra_tmp_idx < N; intra_tmp_idx + +) {
    Prediction
  Calculate cost
  Select candidates
  }
  for (selected candidates) {
  for (intra_tmp_filter_flag = 0; intra_tmp_filter_flag < 2;
intra_tmp_fusion_flag + +) {
    if (intra_tmp_filter) {filter prediction}
  }
  Calculate cost
  }.
```

In the embodiment, the encoder (or decoder) does not consider filtering when constructing the candidate list, but the encoder (or decoder) only sorts the candidate list according to the matching cost for the reference block template and the current block template.

### Second Embodiment

The syntax of the decoder is described as follows:

intra_tmp_flag
if (intra_tmp_flag)
{
intra_tmp_filter_flag
intra_tmp_idx
}.

The specific process of the decoder is described as follows.

If the predicted value of the current block is determined by using the intraTMP technique, then:
1. intra_tmp_filter_flag and intra_tmp_idx are parsed;
2. intraTmpCandList is constructed according to intra_tmp_filter_flag;
3. a BV selected for the current block is determined according to the candidates in intraTmpCandList[intra_tmp_idx]; the reference block is determined; and
4. if a value of intra_tmp_filter_flag is 1 or true, the reference block is filtered. A method is to determine a reference block template according to the selected BV, and to determine the filtering coefficient according to the reference block template and the current block template. The reference block is filtered according to the determined filtering coefficient. The value of the position corresponding to the filtered reference block is taken as the value of the position corresponding to the predicted block. If the value of intra_tmp_filter_flag is 0 or false, the value of the position corresponding to the reference block is used as the value of the position corresponding to the predicted block.

The decoder may take the filtering into account when constructing the list. A method is to filter the reference block template and calculate the matching cost by using the filtered reference block template and the current block template.

More specifically, the decoder may select, according to the value of intra_tmp_filter_flag, whether to construct a list for a non-filtering case or a list for a filtering case. The search methods of the two lists, including the search ranges, search orders, and the list lengths, etc., may be the same or different.

### Parsing Method

If the list lengths are different, intra_tmp_filter_flag is parsed first, and then intra_tmp_idx is parsed.

Further, the binarization and de-binarization methods for intra_tmp_idx of different lists may also be different. Even if the list lengths are the same in both cases, the lists may follow different probability distributions, so that different binarization and debinarization methods may be set for the two lists. As an easy-to-understand example, in a case (such as no filtering) that the probabilities of selecting the first few candidates with small indexes are significantly higher than that of other candidates with larger indexes, the binarization and de-binarization method assigns shorter binary symbols to the first few candidates with small indexes, and assigns longer binary symbols to other candidates with larger indexes. In another case (such as filtering), the probabilities of selecting the first few candidates with small indexes are similar to that of other candidates with larger indexes, and the difference between binary symbol lengths assigned to the candidates with small indexes and to the candidates with larger indexes by binarization and bi-binarization method is not as large as the previous case, or the same lengths of binary symbols are directly used. That is, the codec selects a set of binarization and de-binarization methods according to the value of intra_tmp_filter_flag. For example, if the value of intra_tmp_filter_flag is 0, a first binarization and de-binarization method is selected, and if the value of intra_tmp_filter_flag is 1, a second binarization and de-binarization method is selected.

An example is described as follows.

In the first binarization and de-binarization method, a correspondence relationship between indices and binary symbols is illustrated in Table 3 above.

In the second binarization and de-binarization method, a correspondence relationship between indices and binary symbols is illustrated in Table 4 above.

Further, even if the binarization methods are the same, different context models (CABAC context models) may be set for the two cases in binarization and de-binarization of encoding and decoding, that is, in the two cases, the probabilities of binary symbols in context based coding may be accumulated and updated respectively. Specifically, the codec selects a set of context models according to the value of intra_tmp_filter_flag. For example, if the value of intra_tmp_filter_flag is 0, a set of context models/a context model contextModel0 is selected, and if the value of intra_tmp_filter_flag is 1, a set of context models/a context model contextModel1 is selected.

If the list lengths, binarization and de-binarization methods, context models, etc. are all the same, that is, intra_tmp_idx does not depend on intra_tmp_filter_flag, then either intra_tmp_filter_flag or intra_tmp_idx may be parsed first. Otherwise, i.e., if intra_tmp_idx depends on intra_tmp_filter_flag, then intra_tmp_filter_flag is parsed before parsing intra_tmp_idx.

The decoder reads the bitstream and determines, according to the corresponding relationship table between Symbols and binary symbols, a value of a symbol by using a de-binarization method. If a certain binary symbol is encoded in a context mode, the context model is selected. The encoder determines the content to be written into the bitstream based on a value of Symbol determined by using a binarization method and according to the corresponding relationship table between Symbols and binary symbols, and if a certain binary symbol is encoded in a context mode, the context model is selected. The Symbol corresponds to intra_tmp_idx.

The candidate list construction method is described as follows.

If the filtering is used, the filtering coefficient may be determined according to the reference block template corresponding to the searched BV and the current block template when constructing the list. The reference block template is filtered according to the determined filtering coefficient. The matching cost is calculated by using the filtered reference block template and the current block template. The list is constructed according to the matching cost. The list sorted in an ascending order of matching costs is maintained.

A method is to derive the filtering coefficient as described above for each searched BV, and to filter the reference block template, and so on. The complexity for the decoder of such method is higher than the case that the filtering is not used.

For convenience of expression, the above operations of: determining the filtering coefficient according to the reference block template corresponding to the searched BV and the current block template; filtering the reference block template according to the determined filtering coefficient; and calculating the matching cost by using the filtered reference block template and the current block template, are referred to as a search filtering. The complexity may be reduced by reducing the number of operations of the search filtering. A method is to set a different search method, such as a different search range or different search order, than in the case where the filtering is not used. For example, a smaller search range than that of the case that the filtering is not used may be used.

Another method is to take two steps. The first step is to search without filtering, to screen out a small range of candidate BVs, and then the search filtering is performed on the small range of candidate BVs by use filtering, to finally determine the candidate list.

In an example, regardless of whether the value of intra_tmp_filter_flag is 0 (false) or 1 (true), a candidate list intraTmpUnfilterCandList is constructed without filtering according to the existing method, that is, no filtering is performed. If the value of intra_tmp_filter_flag is 1 (truc), intraTmpFilterCandList is built by using the search filtering based on intraTmpUnfilterCandList. Specifically, the length of the intraTmpUnfilterCandList is recorded as N, the search filtering is performed on each of the first M candidates in the intraTmpUnfilterCandList, and intraTmpFilterCandList[M] is constructed according to the matching costs in the search filtering, and the candidates in the intraTmpFilterCandList are sorted in an ascending order according to the matching costs in the search filtering. M is less than or equal to N. If the value of intra_tmp_filter_flag is 1 (true), intraTmpCandList=intraTmpFilteredCandList, otherwise, i.e., the value of intra_tmp_filter_flag is 0 (false), intraTmpCandList=intraTmpUnfilteredCandList.

The above example may also be understood as regardless of whether the filtering is performed or not, a candidate list that is not filtered is first constructed, and if filtering is required, a candidate list with filtering is constructed according to the candidate list that is not filtered.

The specific process of the encoder is described as follows:
1. the candidate list intraTmpCandList is constructed in the same way as that in the operation 2 of the decoder;
2. the values of intra_tmp_idx and intra_tmp_filter_flag are determined, the predicted value of intraTMP is determined, and the coding cost of using intraTMP is determined; and
3. whether the intraTMP is used for the current block is determined according to the coding cost of intraTMP, and if the intraTMP is used for the current block, the values of intra_tmp_idx and intra_tmp_filter_flag are encoded and written into the bitstream.

The specific method of operation 2 is described as follows.

For two cases where intra_tmp_filter_flag is 0 (false) or 1 (true), the candidate list intraTmpCandList is constructed according to the above candidate list construction methods, respectively.

A BV is determined according to each candidate in the intraTmpCandList, and a reference block corresponding to the BV is determined. If intra_tmp_filter_flag is 0, a predicted block that is not filtered is obtained; and if intra_tmp_filter_flag is 1, a reference block template is determined. The filtering coefficient is determined according to the reference block template and the current block template. The predicted block that is filtered is determined according to the filtering coefficient and the reference block. The distortion cost SAD or SATD is estimated according to comparison of the predicted block and the current block. The coding cost is estimated by adding the estimated distortion cost SAD or SATD and an estimated overhead cost. Several combinations of candidates and filtering are selected according to the estimated coding costs to perform RDO to determine a coding cost. The pseudo code is described as follows:

```
  for (intra_tmp_filter_flag = 0; intra_tmp_filter_flag < 2;
intra_tmp_fusion_flag + +){
  for (intra_tmp_idx = 0; intra_tmp_idx < N; intra_tmp_idx + +) {
    Prediction
  }
  Calculate cost
  }.
```

If the length of the candidate list is M when intra_tmp_filter_flag=1, and M is not equal to N, then the second for loop may be written as: for (intra_tmp_idx=0; intra_tmp_idx<(intra_tmp_filter_flag?M:N); intra_tmp_idx++).

If intra_tmp_filter_flag=0, Prediction is a prediction without filtering, and if intra_tmp_filter_flag=1, Prediction is a prediction with filtering.

However, the RDO may not be performed and the estimated coding cost may be used as the coding cost. This method is generally used in the case where the coding complexity is limited.

Preferred embodiments of the disclosure have been described in detail above with reference to the accompanying drawings. However, the disclosure is not limited to the specific details of the above-mentioned embodiments. Various simple modifications may be made to the technical solution of the present disclosure within the scope of the technical conception of the present disclosure, and these simple modifications shall fall within the scope of protection of the present disclosure. For example, various specific technical features mentioned in the above specific embodiments may be combined in any suitable manner without contradiction, and various possible combinations are not further described in the disclosure in order to avoid unnecessary repetition. For another example, various implementations of the present disclosure may also be arbitrarily combined with each other, as long as the combination does not depart from the idea of the disclosure and the combinations shall also be considered as the content of the disclosure. It should be understood that in various method embodiments of the present disclosure, the sequence number of the above-mentioned operations does not mean an order of execution, and the execution order of the operations is determined by their functions and inherent logic, which should not be limited in any way to the implementation process of the embodiments of the present disclosure.

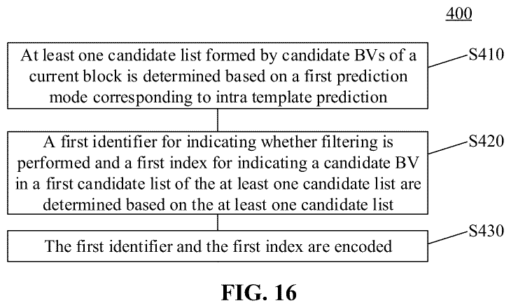

The decoding method according to the embodiments of the present disclosure has been described in detail above from the perspective of the decoder, and an encoding method according to the embodiments of the present disclosure will be described below from the perspective of an encoder with reference to FIG. 16.

FIG. 16 is a schematic flowchart of an encoding method 400 provided in an embodiment of the present disclosure. It should be understood that the encoding method 400 may be performed by an encoder. For example, the encoding method may be applied to the encoding framework 100 illustrated in FIG. 1. For convenience of description, the encoder will be described below as an example.

As illustrated in FIG. 16, the encoding method 400 includes the following operations.

At S410, at least one candidate list formed by candidate BVs of a current block is determined based on a first prediction mode corresponding to intra template prediction.

At S420, a first identifier for indicating whether filtering is performed and a first index for indicating a candidate BV in a first candidate list of the at least one candidate list are determined based on the at least one candidate list.

At S430, the first identifier and the first index are encoded.

In some embodiments, the method 400 may further include the following operations.

A predicted block of the current block is determined based on the first identifier and first index.

A second identifier is determined based on a distortion cost for the predicted block. The second identifier indicates whether the current block is predicted by using the first prediction mode.

The second identifier is encoded.

In some embodiments, the operation S410 may include the following operations.

Template matching is performed on the current block based on the first prediction mode, to obtain a plurality of candidate BVs.

The at least one candidate list is determined based on the plurality of candidate BVs.

In some embodiments, the operation of performing the template matching on the current block based on the first prediction mode, to obtain the plurality of candidate BVs may include the following operation.

The template matching on the current block is performed based on the first prediction mode and according to a parameter corresponding to the first identifier, to obtain the plurality of candidate BVs.

In some embodiments, the parameter corresponding to the first identifier may include at least one of: a search range, a search step size, a search order, or a number of the candidate BVs in the first candidate list.

In some embodiments, the parameter corresponding to the first identifier includes a first search range when the first identifier indicates that the filtering is performed; and the parameter corresponding to the first identifier includes a second search range when the first identifier indicates that the filtering is not performed. The first search range is smaller than the second search range.

In some embodiments, the at least one candidate list includes the first candidate list, and the operation of determining the at least one candidate list based on the plurality of candidate BVs may include the following operations.

Template matching costs for the plurality of candidate BVs are determined.

The plurality of candidate BVs are sorted based on the template matching costs for the plurality of candidate BVs, to obtain the first candidate list.

In some embodiments, the operation S420 may include the following operations.

A distortion cost for a reference block corresponding to the candidate BV in the first candidate list is determined.

Filtering on the reference block corresponding to the candidate BV in the first candidate list is performed, to obtain the distortion cost for the filtered reference block corresponding to the candidate BV in the first candidate list.

The first identifier and the first index are determined based on the distortion cost for the reference block corresponding to the candidate BV in the first candidate list and the distortion cost for the filtered reference block corresponding to the candidate BV in the first candidate list.

In some embodiments, the at least one candidate list includes a second candidate list and a third candidate list, the first candidate list is the second candidate list when the first identifier indicates that the filtering is performed; and the first candidate list is the third candidate list when the first identifier indicates that the filtering is not performed.

In some embodiments, the operation of determining the at least one candidate list based on the plurality of candidate BVs may include the following operations.

Template matching costs for the plurality of candidate BVs are determined.

At least one candidate BV is determined from the plurality of candidate BVs based on the template matching costs for the plurality of candidate BVs.

Filtering on a template corresponding to a candidate BV in the at least one candidate BV is performed to obtain a filtered template corresponding to the candidate BV in the at least one candidate BV.

A template matching cost for the candidate BV in the at least one candidate BV is determined based on the filtered template corresponding to the candidate BV in the at least one candidate BV and a template of the current block.

The at least one candidate BV is sorted based on the template matching cost for the candidate BV in the at least one candidate BV, to obtain the second candidate list.

In some embodiments, the operation of determining the at least one candidate BV from the plurality of candidate BVs based on the template matching costs for the plurality of candidate BVs may include the following operations.

The plurality of candidate BVs are sorted based on the template matching costs for the plurality of candidate BVs.

A portion of the plurality of sorted candidate BVs that is at a top position is determined as the at least one candidate BV.

In some embodiments, the operation of determining the at least one candidate list based on the plurality of candidate BVs may include the following operations.

Template matching costs for the plurality of candidate BVs are determined.

The plurality of candidate BVs are sorted based on the template matching costs for the plurality of candidate BVs, to obtain the third candidate list.

In some embodiments, the operation S420 may include the following operations.

A distortion cost for a reference block corresponding to a candidate BV in the second candidate list is determined.

Filtering on a reference block corresponding to a candidate BV in the third candidate list is performed, to obtain a distortion cost for the filtered reference block corresponding to the candidate BV in the third candidate list.

The first identifier and the first index are determined based on the distortion cost for the reference block corresponding to the candidate BV in the second candidate list and the distortion cost for the filtered reference block corresponding to the candidate BV in the third candidate list.

In some embodiments, the operation S430 may include the following operation.

The first index is encoded based on the first identifier.

In some embodiments, the operation of encoding the first index based on the first identifier may include the following operation.

The first index is encoded based on a binarization method corresponding to the first identifier.

In some embodiments, when the first identifier indicates that the filtering is not performed, the binarization method corresponding to the first identifier includes at least one of a variable-length code binarization method or a truncated unary binarization method; and when the first identifier indicates that the filtering is performed, the binarization method corresponding to the first identifier includes at least one of a fixed-length code binarization method or a truncated binary binarization method.

In some embodiments, the operation of encoding the first index based on the first identifier may include the following operation.

The first index is encoded based on a context model corresponding to the first identifier.

In some embodiments, the method 400 may further include the following operations.

A residual block of the current block is determined based on a predicted block of the current block and an original block of the current block.

A reconstructed block of the current block is determined based on the residual block and the predicted block.

In some embodiments, the method 400 may further include the following operations.

A first template region of a reference block corresponding to the candidate BV indicated by the first index and a second template region of the current block are obtained when the first identifier indicates that the filtering is performed.

A filtering coefficient is determined based on the first template region and the second template region.

In some embodiments, for a first sample in the first template region, filtering on the first sample is performed with a sample in a surrounding region of the first sample, to obtain a filtered second sample; and the filtering coefficient is determined based on a difference between the second sample and a third sample in the second template region. A position of the first sample in the first template region is the same as a position of the third sample in the template region.

In some embodiments, when the sample in the surrounding region of the first sample includes a sample at a first position outside the first template region, the sample at the first position is a sample obtained by padding the first position with a sample in the first template region.

In some embodiments, the filtering coefficient is a coefficient obtained by training.

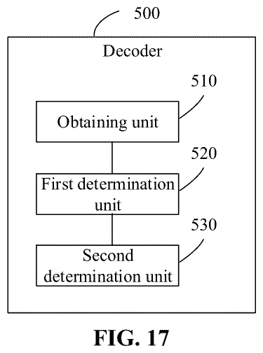

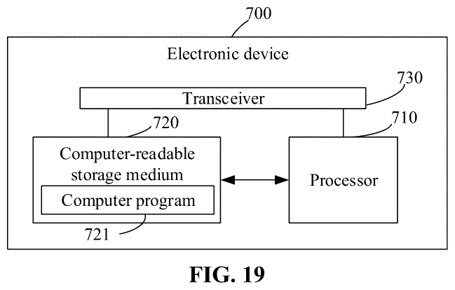

It should be understood that the encoding method may be understood as an inverse process of the decoding method, and therefore, the specific solution of the encoding method 400 may be described in the related contents of the decoding method 300, and for convenience of description, it is not elaborated in the present disclosure again. In addition, the method embodiments of the present disclosure are described in detail above, and apparatus embodiments of the present disclosure will be described in detail below with reference to FIGS. 17 and 19.

FIG. 17 is a schematic block diagram of a decoder 500 provided in an embodiment of the present disclosure.

As illustrated in FIG. 17, the decoder 500 may include an obtaining unit 510, a first determination unit 520 and a second determination unit 530.

The obtaining unit 510 is configured to obtain a first identifier for indicating whether filtering is performed and a first index.

The first determination unit 520 is configured to determine, based on a first prediction mode corresponding to intra template prediction, a first candidate list formed by candidate BVs of a current block.

The second determination unit 530 is configured to determine a predicted block of the current block based on a candidate BV indicated by the first index in the first candidate list and the first identifier.

In some embodiments, the obtaining unit 510 is specifically configured to perform the following operations.

A second identifier is obtained.

The first identifier and the first index are obtained when the second identifier indicates that the current block is predicted by using the first prediction mode.

In some embodiments, the first determination unit 520 is specifically configured to perform the following operations.

Template matching is performed on the current block based on the first prediction mode, to obtain a plurality of candidate BVs.

The first candidate list is determined based on the plurality of candidate BVs.

In some embodiments, the first determination unit 520 is specifically configured to perform the following operations.

The template matching on the current block is performed based on the first prediction mode and according to a parameter corresponding to the first identifier, to obtain the plurality of candidate BVs.

In some embodiments, the parameter corresponding to the first identifier may include at least one of: a search range, a search step size, a search order, or a number of the candidate BVs in the first candidate list.

In some embodiments, the parameter corresponding to the first identifier includes a first search range when the first identifier indicates that the filtering is performed; and the parameter corresponding to the first identifier includes a second search range when the first identifier indicates that the filtering is not performed. The first search range is smaller than the second search range.

In some embodiments, the first determination unit 520 is specifically configured to perform the following operations.

Template matching costs for the plurality of candidate BVs are determined.

The plurality of candidate BVs are sorted based on the template matching costs for the plurality of candidate BVs, to obtain the first candidate list.

In some embodiments, the first determination unit 520 is specifically configured to perform the following operation.

The first candidate list is determined based on the plurality of candidate BVs and the first identifier.

In some embodiments, the first determination unit 520 is specifically configured to perform the following operations.

The template matching costs for the plurality of candidate BVs are determined when the first identifier indicates that the filtering is performed.

At least one candidate BV is determined from the plurality of candidate BVs based on the template matching costs for the plurality of candidate BVs.

Filtering on a template corresponding to a candidate BV in the at least one candidate BV is performed to obtain a filtered template corresponding to the candidate BV in the at least one candidate BV.

A template matching cost for the candidate BV in the at least one candidate BV is determined based on the filtered template corresponding to the candidate BV in the at least one candidate BV and a template of the current block.

The at least one candidate BV is sorted based on the template matching cost for the candidate BV in the at least one candidate BV, to obtain the first candidate list.

In some embodiments, the first determination unit 520 is specifically configured to perform the following operations.

The plurality of candidate BVs are sorted based on the template matching costs for the plurality of candidate BVs.

A portion of the plurality of sorted candidate BVs that is at a top position is determined as the at least one candidate BV.

In some embodiments, the first determination unit 520 is specifically configured to perform the following operations.

The template matching costs for the plurality of candidate BVs are determined when the first identifier indicates that the filtering is not performed.

The plurality of candidate BVs are sorted based on the template matching costs for the plurality of candidate BVs, to obtain the first candidate list.

In some embodiments, the obtaining unit 510 is specifically configured to perform the following operations.

The first identifier is obtained.

The first index is obtained based on the first identifier.

In some embodiments, the obtaining unit 510 is specifically configured to perform the following operation.

The first index is obtained based on a de-binarization method corresponding to the first identifier.

In some embodiments, when the first identifier indicates that the filtering is not performed, the de-binarization method corresponding to the first identifier includes at least one of a variable-length code binarization method or a truncated unary binarization method; and when the first identifier indicates that the filtering is performed, the de-binarization method corresponding to the first identifier includes at least one of a fixed-length code binarization method or a truncated binary binarization method.

In some embodiments, the obtaining unit 510 is specifically configured to perform the following operation.

The first index is obtained based on a context model corresponding to the first identifier.

In some embodiments, the second determination unit 530 is specifically configured to perform the following operations.

Filtering on a reference block corresponding to the candidate BV indicated by the first index is performed to obtain the predicted block when the first identifier indicates that the filtering is performed.

The reference block corresponding to the candidate BV indicated by the first index is determined as the predicted block when the first identifier indicates that the filtering is not performed.

In some embodiments, the second determination unit 530 is further configured to perform the following operations.

A residual block of the current block is obtained.

A reconstructed block of the current block is determined based on the residual block and the predicted block.

In some embodiments, the second determination unit 530 is further configured to perform the following operations.

A first template region of a reference block corresponding to the candidate BV indicated by the first index and a second template region of the current block are obtained when the first identifier indicates that the filtering is performed.

A filtering coefficient is determined based on the first template region and the second template region.

In some embodiments, the second determination unit 530 is specifically configured to perform the following operations.

For a first sample in the first template region, filtering on the first sample is performed with a sample in a surrounding region of the first sample, to obtain a filtered second sample.

The filtering coefficient is determined based on a difference between the second sample and a third sample in the second template region. A position of the first sample in the first template region is the same as a position of the third sample in the template region.

In some embodiments, when the sample in the surrounding region of the first sample includes a sample at a first position outside the first template region, the sample at the first position is a sample obtained by padding the first position with a sample in the first template region.

In some embodiments, the filtering coefficient is a coefficient obtained by training.

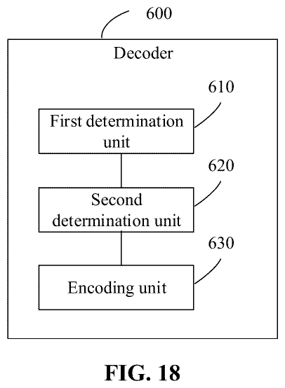

FIG. 18 is a schematic block diagram of an encoder 600 provided in an embodiment of the present disclosure.

As illustrated in FIG. 18, the decoder 600 may include a first determination unit 610, a second determination unit 620 and an encoding unit 630.

The first determination unit 610 is configured to determine, based on a first prediction mode corresponding to intra template prediction, at least one first candidate list formed by candidate BVs of a current block.

The second determination unit 620 is configured to determine, based on the at least one candidate list, a first identifier for indicating whether filtering is performed and a first index for indicating a candidate BV in a first candidate list of the at least one candidate list.

The encoding unit 630 is configured to encode the first identifier and the first index.

In some embodiments, the encoding unit 630 is further configured to perform the following operations.

A predicted block of the current block is determined based on the first identifier and first index.

A second identifier is determined based on a distortion cost for the predicted block. The second identifier indicates whether the current block is predicted by using the first prediction mode.

The second identifier is encoded.

In some embodiments, the first determination unit 610 is specifically configured to perform the following operations.

Template matching is performed on the current block based on the first prediction mode, to obtain a plurality of candidate BVs.

The at least one candidate list is determined based on the plurality of candidate BVs.

In some embodiments, the first determination unit 610 is specifically configured to perform the following operation.

The template matching on the current block is performed based on the first prediction mode and according to a parameter corresponding to the first identifier, to obtain the plurality of candidate BVs.

In some embodiments, the parameter corresponding to the first identifier may include at least one of: a search range, a search step size, a search order, or a number of the candidate BVs in the first candidate list.

In some embodiments, the parameter corresponding to the first identifier includes a first search range when the first identifier indicates that the filtering is performed; and the parameter corresponding to the first identifier includes a second search range when the first identifier indicates that the filtering is not performed. The first search range is smaller than the second search range.

In some embodiments, the at least one candidate list includes the first candidate list, and the first determination unit 610 is specifically configured to perform the following operations.

Template matching costs for the plurality of candidate BVs are determined.

The plurality of candidate BVs are sorted based on the template matching costs for the plurality of candidate BVs, to obtain the first candidate list.

In some embodiments, the second determination unit 620 is specifically configured to perform the following operations.

A distortion cost for a reference block corresponding to the candidate BV in the first candidate list is determined.

Filtering on the reference block corresponding to the candidate BV in the first candidate list is performed, to obtain the distortion cost for the filtered reference block corresponding to the candidate BV in the first candidate list.

The first identifier and the first index are determined based on the distortion cost for the reference block corresponding to the candidate BV in the first candidate list and the distortion cost for the filtered reference block corresponding to the candidate BV in the first candidate list.

In some embodiments, the at least one candidate list includes a second candidate list and a third candidate list, the first candidate list is the second candidate list when the first identifier indicates that the filtering is performed; and the first candidate list is the third candidate list when the first identifier indicates that the filtering is not performed.

In some embodiments, the first determination unit 610 is specifically configured to perform the following operations.

Template matching costs for the plurality of candidate BVs are determined.

At least one candidate BV is determined from the plurality of candidate BVs based on the template matching costs for the plurality of candidate BVs.

Filtering on a template corresponding to a candidate BV in the at least one candidate BV is performed to obtain a filtered template corresponding to the candidate BV in the at least one candidate BV.

A template matching cost for the candidate BV in the at least one candidate BV is determined based on the filtered template corresponding to the candidate BV in the at least one candidate BV and a template of the current block.

The at least one candidate BV is sorted based on the template matching cost for the candidate BV in the at least one candidate BV, to obtain the second candidate list.

In some embodiments, the first determination unit 610 is specifically configured to perform the following operations.

The plurality of candidate BVs are sorted based on the template matching costs for the plurality of candidate BVs.

A portion of the plurality of sorted candidate BVs that is at a top position is determined as the at least one candidate BV.

In some embodiments, the first determination unit 610 is specifically configured to perform the following operations.

Template matching costs for the plurality of candidate BVs are determined.

The plurality of candidate BVs are sorted based on the template matching costs for the plurality of candidate BVs, to obtain the third candidate list.

In some embodiments, the second determination unit 620 is specifically configured to perform the following operations.

A distortion cost for a reference block corresponding to a candidate BV in the second candidate list is determined.

Filtering on a reference block corresponding to a candidate BV in the third candidate list is performed, to obtain a distortion cost for the filtered reference block corresponding to the candidate BV in the third candidate list.

The first identifier and the first index are determined based on the distortion cost for the reference block corresponding to the candidate BV in the second candidate list and the distortion cost for the filtered reference block corresponding to the candidate BV in the third candidate list.

In some embodiments, the encoding unit 630 is specifically configured to perform the following operation.

The first index is encoded based on the first identifier.

In some embodiments, the encoding unit 630 is specifically configured to perform the following operation.

The first index is encoded based on a binarization method corresponding to the first identifier.

In some embodiments, when the first identifier indicates that the filtering is not performed, the binarization method corresponding to the first identifier includes at least one of a variable-length code binarization method or a truncated unary binarization method; and when the first identifier indicates that the filtering is performed, the binarization method corresponding to the first identifier includes at least one of a fixed-length code binarization method or a truncated binary binarization method.

In some embodiments, the encoding unit 630 is specifically configured to perform the following operation.

The first index is encoded based on a context model corresponding to the first identifier.

In some embodiments, the encoding unit 630 is further configured to perform the following operations.

A residual block of the current block is determined based on a predicted block of the current block and an original block of the current block.

A reconstructed block of the current block is determined based on the residual block and the predicted block.

In some embodiments, the second determination unit 620 is further configured to perform the following operations.

A first template region of a reference block corresponding to the candidate BV indicated by the first index and a second template region of the current block are obtained when the first identifier indicates that the filtering is performed.

A filtering coefficient is determined based on the first template region and the second template region.

In some embodiments, the second determination unit 620 is specifically configured to perform the following operations.

For a first sample in the first template region, filtering on the first sample is performed with a sample in a surrounding region of the first sample, to obtain a filtered second sample.

The filtering coefficient is determined based on a difference between the second sample and a third sample in the second template region. A position of the first sample in the first template region is the same as a position of the third sample in the template region.

In some embodiments, when the sample in the surrounding region of the first sample includes a sample at a first position outside the first template region, the sample at the first position is a sample obtained by padding the first position with a sample in the first template region.

In some embodiments, the filtering coefficient is a coefficient obtained by training.

It should be understood that the apparatus embodiments and the method embodiments correspond to each other, and similar descriptions of the device embodiments may refer to the method embodiments. Details will not be elaborated herein again to avoid repeating. Specifically, the decoder 500 illustrated in FIG. 17 may correspond to the entity for performing the method 300 in the embodiments of the present disclosure, and the above and other operations and/or functions of various units in the decoder 500 are used for performing the respective flows in the method 300. Specifically, the encoder 600 illustrated in FIG. 18 may correspond to the entity for performing the method 400 in the embodiments of the present disclosure, and the above and other operations and/or functions of various units in the encoder 600 are used for performing the respective flows in the method 400.

It should also be understood that various units in the decoder 500 or the encoder 600 according to the embodiments of the present disclosure may be configured by separately or completely combining into one or several additional units, or some unit or some units may be further divided into a plurality of units with smaller functions, which can realize the same operation without affecting the realization of the technical effects of the embodiments of the present disclosure. The above-mentioned units are divided based on logical functions, and in practical applications, the functions of one unit may also be implemented by multiple units, or the functions of multiple units may be implemented by one unit. In other embodiments of the present disclosure, the decoder 500 or the encoder 600 may also include other units, and in practical applications, these functions may also be implemented with the assistance of other units, and may be implemented by a plurality of units in cooperation. According to another embodiment of the present disclosure, the decoder 500 or the encoder 600 according to the embodiments of the present disclosure may be constructed and the encoding method or decoding method according to the embodiments of the present disclosure may be implemented by: running a computer program (including program codes) capable of performing operations related to the corresponding methods on a general-purpose computing device such as a general-purpose computer including a processing element such as a central processing unit (CPU) and a storage element such as a random access storage medium (RAM) and a read-only storage medium (ROM). The computer program may be recorded on, for example, a computer-readable storage medium, loaded into an electronic device through the computer-readable storage medium, and executed by the electronic device to perform the corresponding method in the embodiments of the present disclosure.

In other words, the units involved above may be implemented in a hardware form, or implemented by instructions in a software form, or by a combination of hardware and software. Specifically, operations of the method embodiments in the present disclosure may be implemented through a hardware integrated logic circuit and/or software instructions in the processor. The operations of the methods disclosed with reference to the embodiments of the present disclosure may be directly completed by execution by means of a hardware decoding processor, or may be completed by execution by using a combination of hardware and software in the decoding processor. Optionally, the software may be located in a mature storage medium in the field, such as an RAM, a flash memory, an ROM, a programmable ROM (PROM), an electrically-erasable programmable memory, or a register. The storage medium is located in the memory, and the processor reads information in the memory and completes the steps in the foregoing methods mentioned in the above description in combination with hardware of the processor.

FIG. 19 is a schematic structure diagram of an electronic device 700 according to an embodiment of the present disclosure.

As illustrated in FIG. 19, the electronic device 700 includes at least a processor 710 and a computer-readable storage medium 720. The processor 710 and the computer-readable storage medium 720 may be connected through a bus or by other means. The computer-readable storage medium 720 is configured to store a computer program 721 which includes computer instructions. The processor 710 is configured to execute the computer instructions stored in the computer-readable storage medium 720. The processor 710 is a computing core and a control core of the electronic device 700, and is adapted to implement one or more computer instructions, in particular to load and execute one or more computer instructions to perform corresponding method flows or corresponding functions.

Illustratively, the processor 710 may be referred to as a CPU. The processor 710 may include but is not limited to: a general-purpose processor, a digital signal processor (DSP), an application-specific integrated circuit (ASIC), a field programmable gate array (FPGA), or another programmable logical device, transistor logical device, or discrete hardware component.

Illustratively, the computer-readable storage medium 720 may be a high-speed RAM memory or a non-volatile memory, such as at least one magnetic disk storage. Optionally, the computer-readable storage medium may be at least one computer-readable storage medium located remotely from the processor 710. Specifically, the computer-readable storage medium 720 includes, but is not limited to, a volatile memory and/or a non-volatile memory. The non-volatile memory may be an ROM, a PROM, an erasable PROM (EPROM), an electrically EPROM (EEPROM) or a flash memory. The volatile memory may be an RAM and is used as an external cache. By way of illustration, but not limitation, many forms of RAMs may be used, for example, a static RAM (SRAM), a dynamic RAM (DRAM), a synchronous DDRAM (SDRAM), a double data rate SDRAM (DDR SDRAM), an enhanced SDRAM (ESDRAM), a syn chlink DRAM (SLDRAM) and a direct rambus RAM (DR RAM).

Illustratively, the electronic device 700 may be an encoder or an encoding framework according to the embodiments of the present disclosure. The computer-readable storage medium 720 has first computer instructions stored thereon. The processor 710 loads the first computer instructions stored in the computer-readable storage medium 720 and executes the first computer instructions to implement the corresponding steps in the encoding method provided by the embodiments of the present disclosure. In other words, the first computer instructions in the computer-readable storage medium 720 are loaded by the processor 710 to perform corresponding steps, which are not elaborated herein again to avoid repeating.

Illustratively, the electronic device 700 may be a decoder or a decoding framework according to the embodiments of the present disclosure. The computer-readable storage medium 720 has second computer instructions stored thereon. The processor 710 loads the second computer instructions stored in the computer-readable storage medium 720 and executes the second computer instructions to implement the corresponding steps in the decoding method provided by the embodiments of the present disclosure. In other words, the second computer instructions in the computer-readable storage medium 720 are loaded by the processor 710 to perform corresponding steps, which are not elaborated herein again to avoid repeating.

According to another aspect of the present disclosure, the present disclosure also provides a encoding and decoding system including an encoder and a decoder referred to above.

According to another aspect of the present disclosure, there is also provides a computer-readable storage medium (memory) in the present disclosure, which is a memory device in the electronic device 700 for storing programs and data, such as the computer-readable storage medium 720. It is to be understood that the computer-readable storage medium 720 herein may include both a built-in storage medium in the electronic device 700 and an extended storage medium supported by the electronic device 700. The computer-readable storage medium provides a storage space that stores an operating system of the electronic device 700. Moreover, one or more computer instructions adapted to be loaded and executed by the processor 710 are also stored in the storage space, these computer instructions may be one or more computer programs 721 (including program codes).

According to another aspect of the present disclosure, there is also provided a computer program product or a computer program in the present disclosure, the computer program product or the computer program includes computer instructions stored in a computer-readable storage medium. For example, the computer program 721. The data processing device 700 may be a computer. The processor 710 reads the computer instructions from the computer-readable storage medium 720, and the processor 710 executes the computer instructions, to cause the computer to execute the encoding method or decoding method provided in the various optional manners mentioned above.

In other words, when implemented in form of software, the embodiments may be implemented in whole or in part in the form of the computer program product. The computer program product includes one or more computer instructions. When the computer program instructions are loaded and executed on the computer, all or part of the flows in embodiments of the present disclosure are run or all or part of the functions described in embodiments of the present disclosure are generated. The computer may be a general-purpose computer, a special-purpose computer, a computer network, or other programmable devices. The computer instructions may be stored in the computer-readable storage medium or transmitted from the computer-readable storage medium to another computer-readable storage medium. For example, the computer instructions may be transmitted from a Web site, a computer, a server, or a data center to another Web site, computer, server, or data center through a wired (e.g. a coaxial cable, an optical fiber, a digital subscriber line (DSL)) or wireless (e.g. infrared, wireless, microwave, etc.) form.

A person of ordinary skill in the art may be aware that, units and flow steps of various examples described in combination with the embodiments disclosed herein may be implemented by electronic hardware, or a combination of computer software and electronic hardware. Whether the functions are performed by hardware or software depends on particular applications and design constraint conditions of the technical solutions. Those skilled in the art may use different methods to implement the described functions for each particular application, and such implementations should not be considered to go beyond the scope of the present disclosure.

Finally, it is noted that the foregoing descriptions are merely specific implementations of the present disclosure, but are not intended to limit the scope of protection of the present disclosure. Any variation or replacement readily figured out by a person skilled in the art within the technical scope disclosed in the present disclosure shall fall within the scope of protection of the present disclosure. Therefore, the scope of protection of this disclosure shall be subject to the scope of protection of the claims.

1. A decoding method, comprising:
obtaining a first identifier for indicating whether filtering is performed and a first index;
determining, based on a first prediction mode using intra template prediction, a first candidate list obtained based on candidate block vectors (BVs) of a current block; and
determining a predicted block of the current block based on a candidate BV indicated by the first index in the first candidate list and the first identifier.

2. The method of claim 1, wherein obtaining the first identifier for indicating whether the filtering is performed and the first index comprises:
obtaining a second identifier; and
obtaining the first identifier and the first index when the second identifier indicates that the current block is predicted by using the first prediction mode.

3. The method of claim 1, wherein determining, based on the first prediction mode using the intra template prediction, the first candidate list obtained based on the candidate BVs of the current block comprises:
performing template matching on the current block based on the first prediction mode, to obtain a plurality of candidate BVs; and
determining the first candidate list based on the plurality of candidate BVs.

4. The method of claim 3, wherein determining the first candidate list based on the plurality of candidate BVs comprises:
determining template matching costs for the plurality of candidate BVs; and
sorting the plurality of candidate BVs based on the template matching costs for the plurality of candidate BVs, to obtain the first candidate list.

5. The method of claim 1, wherein determining the predicted block of the current block based on the candidate BV indicated by the first index in the first candidate list and the first identifier comprises:
performing filtering on a reference block corresponding to the candidate BV indicated by the first index to obtain the predicted block when the first identifier indicates that the filtering is performed.

6. The method of claim 5, wherein determining the predicted block of the current block based on the candidate BV indicated by the first index in the first candidate list and the first identifier further comprises:
determining the reference block corresponding to the candidate BV indicated by the first index as the predicted block when the first identifier indicates that the filtering is not performed.

7. The method of claim 1, further comprising:
obtaining a residual block of the current block; and
determining a reconstructed block of the current block based on the residual block and the predicted block.

8. The method of claim 1, further comprising:
determining a filtering coefficient based on a first template region and a second template region when the first identifier indicates that the filtering is performed; wherein the first template region is a template region of a reference block corresponding to the candidate BV indicated by the first index and a second template region is a template region of the current block.

9. The method of claim 8, wherein the filtering coefficient is a coefficient obtained by training.

10. An encoding method, comprising:
determining, based on a first prediction mode using to intra template prediction, at least one candidate list obtained based on candidate block vectors (BVs) of a current block;
determining, based on the at least one candidate list, a first identifier for indicating whether filtering is performed and a first index for indicating a candidate BV in a first candidate list of the at least one candidate list; and
encoding the first identifier and the first index.

11. The method of claim 10, further comprising:
determining a predicted block of the current block based on the first identifier and first index;
determining a second identifier based on a distortion cost for the predicted block, the second identifier indicating whether the current block is predicted by using the first prediction mode; and
encoding the second identifier.

12. The method of claim 10, wherein determining, based on the first prediction mode using the intra template prediction, the at least one candidate list obtained based on the candidate BVs of the current block comprises:
performing template matching on the current block based on the first prediction mode, to obtain a plurality of candidate BVs;
determining the at least one candidate list based on the plurality of candidate BVs.

13. The method of claim 12, wherein the at least one candidate list comprises the first candidate list; and
determining the at least one candidate list based on the plurality of candidate BVs comprises:
determining template matching costs for the plurality of candidate BVs; and
sorting the plurality of candidate BVs based on the template matching costs for the plurality of candidate BVs, to obtain the first candidate list.

14. The method of claim 10, further comprising:
determining a residual block of the current block based on a predicted block of the current block and an original block of the current block; and
determining a reconstructed block of the current block based on the residual block and the predicted block.

15. The method of claim 10, further comprising:
obtaining a first template region of a reference block corresponding to the candidate BV indicated by the first index and a second template region of the current block when the first identifier indicates that the filtering is performed; and
determining a filtering coefficient based on the first template region and the second template region.

16. The method of claim 15, wherein the filtering coefficient is a coefficient obtained by training.

17. A non-transitory storage medium having stored thereon computer program/instructions and a bitstream, wherein when the computer program/instructions is/are executed by a processor, the computer program/instructions causes/cause the processor to perform a decoding method to decode the bitstream to generate a video or an image, the decoding method comprising:
obtaining a first identifier for indicating whether filtering is performed and a first index;
determining, based on a first prediction mode using intra template prediction, a first candidate list obtained based on candidate block vectors (BVs) of a current block; and
determining a predicted block of the current block based on a candidate BV indicated by the first index in the first candidate list and the first identifier.

18. The non-transitory storage medium having stored thereon of claim 17, wherein obtaining the first identifier for indicating whether the filtering is performed and the first index comprises:
obtaining a second identifier; and
obtaining the first identifier and the first index when the second identifier indicates that the current block is predicted by using the first prediction mode.

19. The non-transitory storage medium of claim 17, wherein determining, based on the first prediction mode using the intra template prediction, the first candidate list obtained based on the candidate BVs of the current block comprises:
performing template matching on the current block based on the first prediction mode, to obtain a plurality of candidate BVs; and
determining the first candidate list based on the plurality of candidate BVs.

20. A non-transitory storage medium having stored thereon a computer program/instructions and a bitstream, wherein when the computer program/instructions is/are executed by a processor, the computer program/instructions causes/cause the processor to perform the method of claim 10 to generate a bitstream.
